(19) United States
(12) Patent Application Publication
(10) Pub. No.: US 2009/0012152 A1
(43) Pub. Date: Jan. 8, 2009

(54) Use of Tetramic Acid Derivatives for Controlling Insects from the Genus of the Plane Lice (Sternorrhyncha)

(75) Inventors: Reiner Fischer, Monheim (DE); Heike Hungenberg, Langenfeld (DE); Ernst Bruck, Bergisch Gladbach (DE); Ralf Nauen, Langenfeld (DE); Wolfgang Thielert, Odenthal (DE); Xavier Alain Marie Van Waetermeulen, Dusseldorf (DE)

Correspondence Address: STERNE, KESSLER, GOLDSTEIN & FOX P.L.L.C., 1100 NEW YORK AVENUE, N.W., WASHINGTON, DC, 20005, US

(73) Assignee: Bayer CropScience Aktiengesellschaft, Monheim (DE)

(21) Appl. No.: 11/795,714

(22) PCT Filed: Jan. 17, 2006
(86) PCT No.: PCT/EP06/00356

§ 371 Date: Feb. 29, 2008

(30) Foreign Application Priority Data
Jan. 22, 2005 (DE) 10 2005 003 076.9

(51) Int. Cl. A01N 43/36; A01P 15/00

(52) U.S. Cl. 514/425

(57) ABSTRACT

The present invention relates to the use of tetramic acid derivatives of the formula (I)

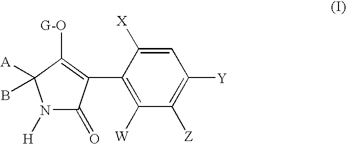

in which
A, B, G, W, X, Y and Z are as defined above
for controlling insects from the suborder of the plant lice (Sternorrhyncha).

The present invention relates to the use of tetramic acid derivatives for controlling insects from the suborder of the plant lice (Sternorrhyncha).

The tetramic acid derivatives are known from EP-A-456 063, EP-A-521 334, EP-A-596 298, EP-A-613 884, WO 95/01 997, WO 95/26 954, WO 95/20 572, EP-A-0 668 267, WO 96/25 395, WO 96/35 664, WO 97/01 535, WO 97/02 243, WO 97/36 868, WO 97/43 275, WO 98/05638, WO 98/06721, WO 98/25928, WO 99/16748, WO 99/24437, WO 99/43649, WO 99/48869 and WO 99/55673, WO 01/09092, WO 01/17972, WO 01/23354, WO 01/74770, WO 03/013249, WO 2004/007 448, WO 2004/024 688, WO 04/065 366, WO 04/080 962, WO 04/111 042, WO 05/044 791, WO 05/044 796, WO 05/048 710, WO 05/049 596, WO 05/066 125.

The insecticidal action of some of these compounds against the species Myzus persicae and Aphis gossypii from the family of the aphids (Aphididae) in vegetable crops such as, for example, brassica vegetables and cotton, is known. The action against the whitefly Bemisia tabaci (Aleyrodidae) on cotton has also been described.

Surprisingly, it has now been found that tetramic acid derivatives are also particularly suitable for controlling further animal pests from the suborder of the plant lice, especially from the families of the gall-making aphids (Pemphigidae), phylloxerans (Phylloxeridae), jumping plant lice (Psyllidae), soft scales (Coccidae), armoured scales (Diaspididae), ensign coccids (Ortheziidae) and mealy bugs (Pseudococcidae).

Furthermore, it has been found that tetramic acid derivatives are also highly active against whiteflies (Aleyrodidae) in further annual crops, such as vegetables, cotton, melons, potatoes, tobacco and, surprisingly, also in perennial crops, such as, for example, citrus fruit, soft fruit, but also ornamental plants and spices.

Moreover, it has been found that tetramic acid derivatives are also very active against aphids (Aphididae) in further annual crops, such as potatoes, tobacco, melons, beet, oilseed rape, cereals, fruit vegetables, tuber vegetables, leafy vegetables, brassica vegetables, root vegetables, stem vegetables, bulb crops, flower-heads/curds as vegetables and, surprisingly, also in perennial crops, such as, for example, citrus fruit, pomme fruit and stone fruit, nuts, almonds, soft fruit, grapevines and hops, and also in tropical crops, ornamental plants and spices.

Accordingly, the present invention relates to the use of tetramic acid derivatives for controlling insects from the families a) of the gall-making aphids (Pemphigidae), phylloxerans (Phylloxeridae), jumping plant lice (Psyllidae), soft scales (Coccidae), armoured scales (Diaspididae), ensign coccids (Ortheziidae) and mealy bugs (Pseudococcidae) in annual and perennial and also tropical crops, and also b) for controlling pests from the family of the whiteflies (Aleyrodidae) in further annual crops, such as vegetables, potatoes, tobacco, melons, cotton and, surprisingly, also in perennial crops, such as, for example, citrus fruit, soft fruit, but also ornamental plants and spices and in tropical crops, and c) for controlling insects from the family of the aphids (Aphididae) in further annual crops, such as potatoes, tobacco, melons, beet, oilseed rape, cereal, fruit vegetables, tuber vegetables, leafy vegetables, brassica vegetables, root vegetables, stem vegetables, bulb crops, flower-heads/curds as vegetables and, surprisingly, also in perennial crops, such as, for example, citrus fruit, pomme fruit and stone fruit, nuts, almonds, soft fruit, grapevines and hops, and also tropical crops, ornamental plants and spices.

The crops to be protected, which have only been described in a general manner, are described in a more differentiated and more specific manner below. Thus, with respect to the use, vegetable is to be understood as meaning, for example, fruit vegetable and flower-heads/curds as vegetables, for example bell peppers, chilli peppers, tomatoes, aubergines, cucumbers, cucurbits, courgettes, broad beans, runner beans, bush beans, peas, artichokes, maize;

but also leafy vegetables, for example lettuce, chicory, endives, cress, rocket salad, field salad, iceberg lettuce, leek, spinach, Swiss chard;
furthermore tuber vegetables, root vegetables and stem vegetables, for example celeriac, beetroot, carrots, garden radish, horseradish, scorzonera, asparagus, table beet, palm shoots, bamboo shoots, moreover bulb vegetables, for example onions, leek, fennel, garlic;
furthermore brassica vegetables, such as cauliflowers, broccoli, kohlrabi, red cabbage, white cabbage, green cabbage, Savoy cabbage, Brussels sprouts, Chinese cabbage.

Thus, with respect to the use in cereal crops, cereal is to be understood as meaning, for example, wheat, barley, rye, oats, triticale but also maize, millet and rice;

with respect to the use, perennial crops are to be understood as meaning citrus fruit, such as, for example, oranges, grapefruit, mandarins, lemons, limes, bitter oranges, cumquats, satsumas;
but also pomme fruit, such as, for example, apples, pears and quince, and stone fruit, such as, for example, peaches, nectarines, cherries, plums, common plums, apricots;
furthermore grapevine, hops, olives, tea, and tropical crops, such as, for example, mangoes, papayas, figs, pineapples, dates, bananas, durians, kakis, coconuts, cacao, coffee, avocados, litchis, maracujas, guavas,
moreover almonds and nuts, such as, for example, hazelnuts, walnuts, pistachios, cashew nuts, brazil nuts, pecan nuts, butter nuts, chestnuts, hickory nuts, macadamia nuts, peanuts,
additionally also soft fruit, such as, for example, blackcurrants, gooseberries, raspberries, blackberries, blueberries, strawberries, red bilberries, kiwis, cranberries.

With respect to the use, ornamental plants are to be understood as meaning annual and perennial plants, for example cut flowers, such as, for example, roses, carnations, gerbera, lilies, marguerites, chrysanthemums, tulips, daffodils, anemones, poppies, amaryllis, dahlias, azaleas, malves,

but also, for example, bedding plants, potted plants and shrubs, such as, for example, roses, tagetes, pansies, geraniums, fuchsias, hibiscus, chrysanthemums, busy lizzies, cyclamen, African violets, sunflowers, begonias,
furthermore, for example, bushes and conifers, such as, for example, fig trees, rhododendron, spruce trees, fir trees, pine trees, yew trees, juniper trees, stone pines, rose bays.

With respect to the use, spices are to be understood as meaning annual and perennial plants, such as, for example, aniseed, chilli pepper, bell pepper, pepper, vanilla, marjoram, thyme, cloves, juniper berries, cinnamon, estragon, coriander, saffron, ginger.

The tetramic acid derivatives are compounds of the formula (I)

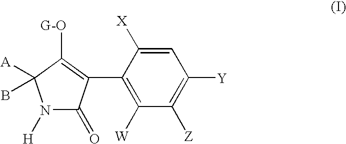

in which
X represents halogen, alkyl, alkoxy, haloalkyl, haloalkoxy or cyano,
W, Y and Z independently of one another represent hydrogen, halogen, alkyl, alkoxy, haloalkyl, haloalkoxy or cyano,
A represents hydrogen, in each case optionally halogen-substituted alkyl, alkoxyalkyl, saturated, optionally substituted cycloalkyl in which optionally at least one ring atom is replaced by a heteroatom,
B represents hydrogen or alkyl, or
A and B together with the carbon atom to which they are attached represent a saturated or unsaturated, unsubstituted or substituted cycle which optionally contains at least one heteroatom,
G represents hydrogen (a) or represents one of the groups

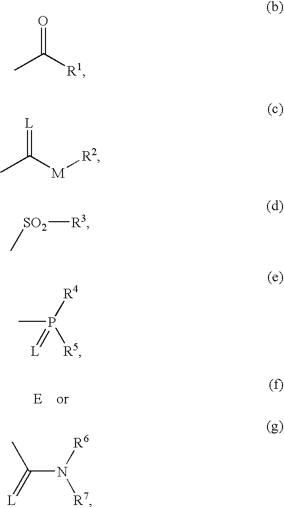

in which
E represents a metal ion or an ammonium ion,
L represents oxygen or sulphur,
M represents oxygen or sulphur,
R¹ represents in each case optionally halogen-substituted alkyl, alkenyl, alkoxyalkyl, alkylthioalkyl, polyalkoxyalkyl or optionally halogen-, alkyl- or alkoxy-substituted cycloalkyl which may be interrupted by at least one heteroatom, represents in each case optionally substituted phenyl, phenylalkyl, hetaryl, phenoxyalkyl or hetaryloxyalkyl,
R² represents in each case optionally halogen-substituted alkyl, alkenyl, alkoxyalkyl, polyalkoxyalkyl or represents in each case optionally substituted cycloalkyl, phenyl or benzyl,
R³ represents optionally halogen-substituted alkyl or optionally substituted phenyl,
R⁴ and R⁵ independently of one another represent in each case optionally halogen-substituted alkyl, alkoxy, alkylamino, dialkylamino, alkylthio, alkenylthio, cycloalkylthio or represent in each case optionally substituted phenyl, benzyl, phenoxy or phenylthio and
R⁶ and R⁷ independently of one another represent hydrogen, in each case optionally halogen-substituted alkyl, cycloalkyl, alkenyl, alkoxy, alkoxyalkyl, represent optionally substituted phenyl, represent optionally substituted benzyl or together with the nitrogen atom to which they are attached represent an optionally substituted ring which is optionally interrupted by oxygen or sulphur
in the form of their isomer mixtures or pure isomers.

Preference is given to using tetramic acid derivatives of the formula (I) mentioned above in which the radicals are as defined below:
W preferably represents hydrogen, C₁-C₄-alkyl, C₁-C₄-alkoxy, chlorine, bromine or fluorine,
X preferably represents C₁-C₄-alkyl, C₁-C₄-alkoxy, C₁-C₄-haloalkyl, fluorine, chlorine or bromine,
Y and Z independently of one another preferably represent hydrogen, C₁-C₄-alkyl, halogen, C₁-C₄-alkoxy or C₁-C₄-haloalkyl,
A preferably represents hydrogen or in each case optionally halogen-substituted C₁-C₆-alkyl or C₃-C₈-cycloalkyl,
B preferably represents hydrogen, methyl or ethyl,
A, B and the carbon atom to which they are attached preferably represent saturated C₃-C₆-cycloalkyl in which optionally one ring member is replaced by oxygen or sulphur and which is optionally mono- or disubstituted by C₁-C₄-alkyl, trifluoromethyl or C₁-C₄-alkoxy,
G preferably represents hydrogen (a) or represents one of the groups

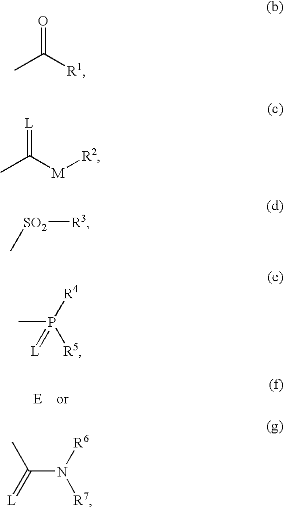

in particular (a), (b), (c) or (g),
   in which
   E represents a metal ion or an ammonium ion,
   L represents oxygen or sulphur and
   M represents oxygen or sulphur,
R¹ preferably represents in each case optionally halogen-substituted C₁-C₁₀-alkyl, C₂-C₁₀-alkenyl, C₁-C₄-alkoxy-C₁-C₄-alkyl, C₁-C₄-alkylthio-C₁-C₄-alkyl or optionally fluorine-, chlorine-, C₁-C₄-alkyl- or C₁-C₂-alkoxy-substituted C₃-C₆-cycloalkyl,
represents optionally fluorine-, chlorine-, bromine-, cyano-, nitro-, C₁-C₄-alkyl-, C₁-C₄-alkoxy-, trifluoromethyl- or trifluoromethoxy-substituted phenyl,
represents in each case optionally chlorine- or methyl-substituted pyridyl or thienyl,
R² preferably represents in each case optionally fluorine- or chlorine-substituted C₁-C₁₀-alkyl, C₂-C₁₀-alkenyl, C₁-C₄-alkoxy-C₂-C₄-alkyl,
represents optionally methyl- or methoxy-substituted C₅-C₆-cycloalkyl or
represents in each case optionally fluorine-, chlorine-, bromine-, cyano-, nitro-, C₁-C₄-alkyl-, C₁-C₄-alkoxy-, trifluoromethyl- or trifluoromethoxy-substituted phenyl or benzyl,
R³ preferably represents optionally fluorine-substituted C₁-C₄-alkyl or represents optionally fluorine-, chlorine-, bromine-, C₁-C₄-alkyl-, C₁-C₄-alkoxy-, trifluoromethyl-, trifluoromethoxy-, cyano- or nitro-substituted phenyl,
R⁴ preferably represents in each case optionally fluorine- or chlorine-substituted C₁-C₄-alkyl, C₁-C₄-alkoxy, C₁-C₄-alkylamino, C₁-C₄-alkylthio or represents in each case optionally fluorine-, chlorine-, bromine-, nitro-, cyano-, C₁-C₄-alkoxy-, trifluoromethoxy-, C₁-C₄-alkylthio-, C₁-C₄-haloalkylthio-, C₁-C₄-alkyl- or trifluoromethyl-substituted phenyl, phenoxy or phenylthio,
R⁵ preferably represents C₁-C₄-alkoxy or C₁-C₄-thioalkyl,
R⁶ preferably represents C₁-C₆-alkyl, C₃-C₆-cycloalkyl, C₁-C₆-alkoxy, C₃-C₆-alkenyl or C₁-C₄-alkoxy-C₁-C₄-alkyl,
R⁷ preferably represents C₁-C₆-alkyl, C₃-C₆-alkenyl or C₁-C₄-alkoxy-C₁-C₄-alkyl,
R⁶ and R⁷ together preferably represent an optionally methyl- or ethyl-substituted C₃-C₆-alkylene radical in which optionally one carbon atom is replaced by oxygen or sulphur
   in the form of their isomer mixtures or pure isomers.

Particular preference is given to using tetramic acid derivatives of the formula (I) mentioned above in which the radicals are as defined below:
W particularly preferably represents hydrogen, methyl, ethyl, chlorine, bromine or methoxy,
X particularly preferably represents chlorine, bromine, methyl, ethyl, propyl, isopropyl, methoxy, ethoxy or trifluoromethyl,
Y and Z independently of one another particularly preferably represent hydrogen, fluorine, chlorine, bromine, methyl, ethyl, propyl, isopropyl, trifluoromethyl or methoxy,
A particularly preferably represents methyl, ethyl, propyl, isopropyl, butyl, isobutyl, sec-butyl, tert-butyl, cyclopropyl, cyclopentyl or cyclohexyl,
B particularly preferably represents hydrogen, methyl or ethyl, or
A, B and the carbon atom to which they are attached particularly preferably represent saturated C₆-cycloalkyl in which optionally one ring member is replaced by oxygen and which is optionally monosubstituted by methyl, ethyl, trifluoromethyl, methoxy, ethoxy, propoxy or butoxy,
G particularly preferably represents hydrogen (a) or represents one of the groups

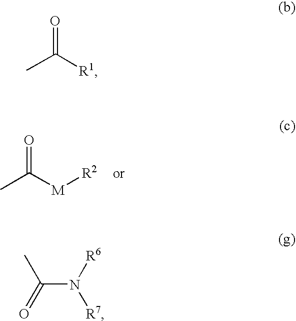

in which
M represents oxygen or sulphur,
R¹ particularly preferably represents C₁-C₈-alkyl, C₂-C₄-alkenyl, methoxymethyl, ethoxymethyl, ethylthiomethyl, cyclopropyl, cyclopentyl or cyclohexyl,
represents phenyl which is optionally mono- or disubstituted by fluorine, chlorine, bromine, cyano, nitro, methyl, ethyl, methoxy, trifluoromethyl or trifluoromethoxy,
or represents in each case optionally chlorine- or methyl-substituted pyridyl or thienyl,
R² particularly preferably represents C₁-C₈-alkyl, C₂-C₄-alkenyl, methoxyethyl, ethoxyethyl or represents phenyl or benzyl,
R⁶ and R⁷ independently of one another particularly preferably represent methyl, ethyl or together represent a C₅-alkylene radical in which the C₃-methylene group is replaced by oxygen
   in the form of their isomer mixtures or pure isomers.

Very particular preference is given to using tetramic acid derivatives of the formula (I) mentioned above in which the radicals are as defined below:
W very particularly preferably represents hydrogen or methyl,
X very particularly preferably represents chlorine, bromine or methyl,
Y and Z independently of one another very particularly preferably represent hydrogen, chlorine, bromine or methyl,
A, B and the carbon atom to which they are attached very particularly preferably represent saturated C₆-cycloalkyl in which optionally one ring member is replaced by oxygen and which is optionally monosubstituted by methyl, trifluoromethyl, methoxy, ethoxy, propoxy or butoxy,
G very particularly preferably represents hydrogen (a) or represents one of the groups

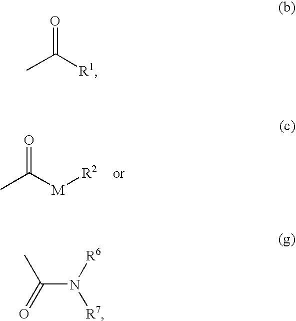

in which
M represents oxygen or sulphur,
R¹ very particularly preferably represents C₁-C₈-alkyl, C₂-C₄-alkenyl, methoxymethyl, ethoxymethyl, ethylthiomethyl, cyclopropyl, cyclopentyl, cyclohexyl or
represents phenyl which is optionally monosubstituted by fluorine, chlorine, bromine, methyl, methoxy, trifluoromethyl, trifluoromethoxy, cyano or nitro,
represents in each case optionally chlorine- or methyl-substituted pyridyl or thienyl,
R² very particularly preferably represents C₁-C₈-alkyl, C₂-C₄-alkenyl, methoxyethyl, ethoxyethyl, phenyl or benzyl,
R⁶ and R⁷ independently of one another very particularly preferably represent methyl, ethyl or together represent a C₅-alkylene radical in which the C₃-methylene group is replaced by oxygen
   in the form of their isomer mixtures or pure isomers.

Special preference is given to using tetramic acid derivatives of the formula (I) mentioned above in which the radicals are as defined below (I):

| | |
|---|---|
| | (I) |
| 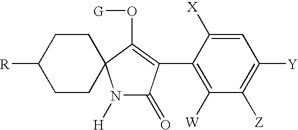 | |

| Example | | | | | | | m.p. |
|---|---|---|---|---|---|---|---|
| No. | W | X | Y | Z | R | G | ° C. |
| I-1 | H | Br | H | CH₃ | OCH₃ | CO-i-C₃H₇ | 122 |
| I-2 | H | Br | H | CH₃ | OCH₃ | CO₂—C₂H₅ | 140-142 |
| I-3 | H | CH₃ | H | CH₃ | OCH₃ | H | >220 |
| I-4 | H | CH₃ | H | CH₃ | OCH₃ | CO₂—C₂H₅ | 128 |
| I-5 | CH₃ | CH₃ | H | Br | OCH₃ | H | >220 |
| I-6 | CH₃ | CH₃ | H | Cl | OCH₃ | H | 219 |
| I-7 | H | Br | CH₃ | CH₃ | OCH₃ | CO-i-C₃H₇ | 217 |
| I-8 | H | CH₃ | Cl | CH₃ | OCH₃ | CO₂C₂H₅ | 162 |
| I-9 | CH₃ | CH₃ | CH₃ | CH₃ | OCH₃ | H | >220 |
| I-10 | CH₃ | CH₃ | H | Br | OC₂H₅ | CO-i-C₃H₇ | 212-214 |
| I-11 | H | CH₃ | CH₃ | CH₃ | OC₂H₅ | CO-n-C₃H₇ | 134 |
| I-12 | H | CH₃ | CH₃ | CH₃ | OC₂H₅ | CO-i-C₃H₇ | 108 |
| I-13 | H | CH₃ | CH₃ | CH₃ | OC₂H₅ | CO-c-C₃H₅ | 163 |

in the form of their cis/trans isomer mixtures or their pure cis isomers.

The compounds of the formula (I) are known compounds whose preparation is described in the patents/patent applications cited on page 1 (see especially WO 97/01 535, WO 97/36 868, WO 98/05 638).

From the family of the gall-making aphids (Phemphigidae), preference is given to: Eriosoma spp., Pemphigus spp., Anuraphis spp., in crops such as, for example, citrus fruit, pomme fruit, stone fruit, vegetables, beet, cereals and ornamental plants.

From the family of the phylloxerans (Phylloxeridae), preference is given to: Phylloxera spp. in grapevines, nuts, citrus fruit.

From the family of the jumping plant lice (Psyllidae), preference is given to: Psylla spp., Paratrioza spp., Tenalaphara spp., Diaphorina spp., Trioza spp., in crops such as, for example, pomme fruit, stone fruit, citrus fruit, vegetables, potatoes, in tropical crops.

From the family of the soft scales (Coccidae), preference is given to: Ceroplastes spp., Drosicha spp., Pulvinaria spp., Protopulminaria spp., Saissetia spp., Coccus spp., in perennial crops such as, for example, citrus fruit, pomme fruit, stone fruit, olives, grapevines, coffee, tea, tropical crops, ornamental plants, vegetables.

From the family of the armoured scales (Diaspididae), preference is given to: Quadraspidiotus spp., Aonidiella spp., Lepidosaphes spp., Aspidiotus spp., Aspis spp., Diaspis spp., Parlatoria spp., Pseudaulacaspis spp., Unaspis spp., Pinnaspis spp., Selenaspidus spp., in crops such as, for example, citrus fruit, pomme fruit, stone fruit, almonds, nuts, olives, tea, ornamental plants, grapevines, tropical crops.

From the family of the ensign coccids (Ortheziidae), preference is given to: Orthezia spp. in citrus fruit, pomme fruit, stone fruit.

From the family of the mealy bugs (Pseudococcidae), preference is given to: Pericerga, Pseudococcus spp., Planococcus spp., Dysmicoccus spp., in crops such as, for example, citrus fruit, stone fruit and pomme fruit, tea, grapevines, vegetables, ornamental plants and tropical crops.

From the family of the whiteflies (Aleyrodidae), preference is furthermore given to: Bemisia argentifolii, Trialeurodes vaporariorum, Aleurothrixus floccosus, Aleurodes spp., Dialeurodes spp., Parabemisia myricae in crops such as, for example, vegetables, melons, potatoes, tobacco, soft fruit, citrus fruit, ornamental plants, cotton and tropical crops, and also Bemisia tabaci in crops such as, for example, vegetables, melons, soft fruit, tobacco, citrus fruit, ornamental plants, potatoes and tropical crops.

From the family of the aphids (Aphidae), preference is furthermore given to:
Myzus spp. in tobacco, cereals, stone fruit, soft fruit, fruit vegetables, leafy vegetables, tuber and root vegetables, melons, potatoes, beet, oilseed rape, ornamental plants,
Aphis spp. in tobacco, citrus fruit, pomme fruit, stone fruit, cereals, melons, beet, soft fruit, oilseed rape, fruit vegetables, leafy vegetables, brassica vegetables, tuber and root vegetables, ornamental plants, potatoes, cucurbits,
Rhodobium porosum in strawberries,
Nasonovia ribisnigri in leafy vegetables,
Dysaphis spp. in pomme fruit,
Macrosiphum spp. in ornamental plants, cereals, potatoes, leafy vegetables, brassica vegetables and fruit vegetables, strawberries,
Rhopalosiphum padi, Sitobion avenae, Methopolophium dirhodum, Brachycolus noxius in cereals,
Phorodon humuli in hops,
Brachycaudus helychrisii in stone fruit, such as, for example, plums,
Toxoptera spp. in citrus fruit, stone fruit, almonds, nuts, cereals, spices,
Aulacorthum spp. in citrus fruit, potatoes, fruit vegetables and leafy vegetables.

Very particular preference is given to the control of the following species from the family of the gall-making aphids (Pemphigidae) in the following crops, preferably after foliar application:
Eriosoma lanigerum in pomme fruit and stone fruit such as, for example, apples, pears, cherries, plums, garden plums,
Eriosoma pyricola in pomme fruit such as apples and pears,
Pemphigus fuscicornis, Pemphigus bursarius in beet, vegetables, ornamental plants.

All plants and plant parts can be treated in accordance with the invention. In this context, plants are understood as meaning all plants and plant populations such as desired and undesired wild plants or crop plants (including naturally occurring crop plants). Crop plants can be plants which can be obtained by traditional breeding and optimization methods or by biotechnological and recombinant methods, or combinations of these methods, including the transgenic plants and including the plant varieties which are capable or not capable of being protected by Plant Breeders' Rights. Plant parts are understood as meaning all aerial and subterranean parts and organs of the plants such as shoot, leaf, flower and root, examples which may be mentioned being leaves, needles, stalks, stems, flowers, fruit bodies, fruits and seeds, but also roots, tubers and rhizomes. The plant parts also include crop material and vegetative and generative propagation material, for example cuttings, tubers, rhizomes, slips and seeds.

The treatment according to the invention with the active compound, of the plants and plant parts, is effected directly or by treating their environment, habitat or store using conventional treatment methods, for example by dipping, spraying, fumigating, fogging, scattering, brushing on, injecting, and, in the case of propagation material, in particular seeds, furthermore by coating with one or more coats.

As already mentioned above, all plants and their parts can be treated in accordance with the invention. In a preferred embodiment, plant species and plant varieties which are found in the wild or which are obtained by traditional biological breeding methods, such as hybridization or protoplast fusion, and parts of these species and varieties are treated. In a further preferred embodiment, transgenic plants and plant varieties which have been obtained by recombinant methods, if appropriate in combination with traditional methods (genetically modified organisms) and their parts are treated. The terms “parts”, “parts of plants” or “plant parts” have been described above.

Plants which are especially preferably treated in accordance with the invention are those of the varieties which are in each case commercially available or in use. Plant varieties are understood as meaning plants with novel traits which have been bred both by conventional breeding, by mutagenesis or by recombinant DNA techniques. They may take the form of varieties, biotypes or genotypes.

Depending on the plant species or plant varieties, their location and growth conditions (soils, climate, vegetation period, nutrition), superadditive (“synergistic”) effects may also occur as a result of the treatment according to the invention. Effects which exceed the effects actually to be expected are, for example, reduced application rates and/or widened activity spectrum and/or an enhancement of the activity of the substances and compositions which can be used in accordance with the invention, better plant growth, increased tolerance to high or low temperatures, increased tolerance to drought or to water or soil salinity, increased flowering performance, facilitated harvest, speedier maturation, higher yields, higher quality and/or higher nutritional value of the crop products, better storability and/or processibility of the crop products.

The preferred transgenic plants or plant varieties (plants or plant varieties obtained by means of genetic engineering) which are to be treated in accordance with the invention include all plants which, by means of the recombinant modification, have received genetic material which confers particularly advantageous valuable traits to these plants. Examples of such traits are better plant growth, increased tolerance to high or low temperatures, increased tolerance to drought or to water or soil salinity, increased flowering performance, facilitated harvest, speedier maturation, higher yields, higher quality and/or higher nutritional value of the crop products, better storability and/or processibility of the crop products. Other examples of such traits which are particularly emphasized are an improved defense of the plants against animal and microbial pests such as insects, mites, phytopathogenic fungi, bacteria and/or viruses, and an increased tolerance of the plants to specific herbicidal active compounds. Examples of transgenic plants which are mentioned are the important crop plants such as cereals (wheat, rice), maize, soybean, potato, cotton, tobacco, oilseed rape and fruit plants (with the fruits apples, pears, citrus fruits and grapes), with particular emphasis on maize, soybean, potatoes, cotton, tobacco and oilseed rape. Traits which are particularly emphasized are the increased defense of the plants against insects, arachnids, nematodes and slugs and snails as the result of toxins formed in the plants, in particular toxins which are produced in the plants by the genetic material of Bacillus Thuringiensis (for example by the genes CryIA(a), CryIA(b), CryIA(c), CryIIA, CryIIIA, CryIIIB2, Cry9c, Cry2Ab, Cry3Bb and CryIF and their combinations) (hereinbelow “Bt plants”). Traits which are also particularly emphasized are the increased defense of plants against fungi, bacteria and viruses by systemic acquired resistance (SAR), systemin, phytoalexins, elicitors and resistance genes and correspondingly expressed proteins and toxins. Traits which are furthermore especially emphasized are the increased tolerance of the plants to specific herbicidal active compounds, for example imidazolinones, sulphonylureas, glyphosate or phosphinothricin (for example “PAT” gene). The specific genes which confer the desired traits can also occur in combinations with one another in the transgenic plants. Examples of “Bt plants” which may be mentioned are maize varieties, cotton varieties, soybean varieties and potato varieties sold under the trade names YIELD GARD® (for example maize, cotton, soybean), KnockOut® (for example maize), StarLink® (for example maize), Bollgard®& (cotton), Nucotn® (cotton) and NewLeaf® (potato). Examples of herbicide-tolerant plants which may be mentioned are maize varieties, cotton varieties and soybean varieties which are sold under the trade names Roundup Ready® (glyphosate tolerance, for example maize, cotton, soybean), Liberty Link® (phosphinothricin tolerance, for example oilseed rape), IMI® (imidazolinone tolerance) and STS® (sulphonylurea tolerance, for example maize). Herbicide-resistant plants (bred conventionally for herbicide tolerance) which may also be mentioned are the varieties sold under the name Clearfield® (for example maize). Naturally, what has been said also applies to plant varieties which will be developed, or marketed, in the future and which have these genetic traits or traits to be developed in the future.

The active compound of the formula (I) can be converted into the customary formulations, such as solutions, emulsions, wettable powders, suspensions, powders, dusts, pastes, soluble powders, granules, suspoemulsion concentrates, natural and synthetic materials impregnated with active compound, and ultrafine encapsulations in polymeric materials.

These formulations are produced in the known manner, for example by mixing the active compound with extenders, that is, liquid solvents and/or solid carriers, optionally with the use of surfactants, that is, emulsifiers and/or dispersants and/or foam formers.

In the case of the use of water as an extender, organic solvents can, for example, also be used as cosolvents. Liquid solvents which are suitable are mainly: aromatics, such as xylene, toluene or alkylnaphthalenes, chlorinated aromatics or chlorinated aliphatic hydrocarbons, such as chlorobenzenes, chloroethylenes or methylene chloride, aliphatic hydrocarbons, such as cyclohexane or paraffins, for example mineral oil fractions, mineral oils and vegetable oils, alcohols, such as butanol or glycol as well as their ethers and esters, ketones, such as acetone, methyl ethyl ketone, methyl isobutyl ketone or cyclohexanone, strongly polar solvents, such as dimethylformamide and dimethyl sulphoxide, and water.

Solid carriers which are suitable are:

for example ammonium salts and ground natural minerals, such as kaolins, clays, talc, chalk, quartz, attapulgite, montmorillonite or diatomaceous earth, and ground synthetic minerals, such as highly-disperse silica, alumina and silicates; suitable solid carriers for granules are: for example crushed and fractionated natural rocks such as calcite, marble, pumice, sepiolite and dolomite, and synthetic granules of inorganic and organic meals, and granules of organic material such as sawdust, coconut shells, maize cobs and tobacco stalks; suitable emulsifiers and/or foam formers are: for example non-ionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates as well as protein hydrolysates; suitable dispersants are: for example lignosulphite waste liquors and methylcellulose.

Adhesives such as carboxymethylcellulose and natural and synthetic polymers in the form of powders, granules or lattices, such as gum arabic, polyvinyl alcohol and polyvinyl acetate, and natural phospholipids, such as cephalins and lecithins, and synthetic phospholipids, can be used in the formulations. Other additives can be mineral and vegetable oils.

It is possible to use colorants such as inorganic pigments, for example iron oxide, titanium oxide and Prussian Blue, and organic dyestuffs, such as alizarin dyestuffs, azo dyestuffs and metal phthalocyanine dyestuffs, and trace nutrients such as salts of iron, manganese, boron, copper, cobalt, molybdenum and zinc.

The formulations in general comprise between 0.1 and 95% by weight of active compound, preferably between 0.5 and 90%, and additionally preferably extenders and/or surfactants.

The active compound content of the use forms prepared from the commercially available formulations can vary within wide ranges. The active compound concentration of the use forms can be in the range of from 0.0000001 up to 95% by weight of active compound, preferably between 0.0001 and 1% by weight.

Application is in a customary manner which is appropriate for the use forms.

### USE EXAMPLES

### Gall-Making Aphids

### Pemphigidae

Very particular preference is given to controlling the following species from the family of the gall-making aphids (Pemphigidae):

Eriosoma lanigerum in pomme fruit, such as, for example, apples, pears, and stone fruit, such as, for example, cherries, plums, garden plums,
Eriosoma pyricola in pomme fruit, such as, for example, apples and pears,
Pemphigus bursarius, in ornamental plants, such as, for example, chrysanthemums, in vegetables, such as, for example, head lettuce,
Pemphigus fuscicornis in beet, leafy vegetables, such as, for example, head lettuce, root vegetables, such as, for example, carrots, ornamental plants, such as, for example, chrysanthemums,
Anuraphis cardui in vegetables, such as, for example, artichokes.

### Example 1

Two about 23-year-old apple trees of the cultivar “Idared” infested by Eriosoma lanigerum are, under practical conditions, treated with Example (I-9) (240 SC) and Example (I-4) (240 SC) in comparison to the commercial standard imidacloprid 200 SL at the stated application rates. Application is with a motor-operated knapsack sprayer. The application rate is 1500 l of water/ha.

Evaluation is carried out 15 and 37 days after the application by rating the kill in percent on the branches.

| | Application rate | Kill | | |
|---|---|---|---|---|
| Active | g of a.i./ha/height | (%) | | |
| compound | of crown in m | 7 d | 14 d | 21 d |
| amitraz | 266 | 100 | 95.2 | 75 |
| Example (I-4) | 72 | 100 | 100 | 100 |

### Example 2

In three replications, in each case 10 109-day-old chrysanthemums of the cultivar “Camilla” in 2 l-vessels are treated against the lettuce root aphid Pemphigus bursarius. Here, the active compounds Example (I-9) (240 SC) and Example (I-2) (240 SC) are applied with a knapsack sprayer operated by pressurized air at the stated application rates only to the above-ground parts of the plants. The soil is covered with a film. The application rate is 300 l of water/ha. 0.1% a.i. of rapeseed oil methyl ester (500 EW) is added to the spray liquor.

The kill in percent is determined on the roots. 21 and 29 days after the application, the following results are obtained:

| | | |
|---|---|---|
| Active | Application rate | Kill (%) |

| compound | a.i. in % | 21 d | 29 d |
|---|---|---|---|
| Example (I-9) | 144 | 76.5 | 94.0 |
| Example (I-2) | 96 | 80.8 | 91.8 |

### Example 3

In three replications, in each case 10 about 5-month-old chrysanthemums (Camilla) in 2 l-vessels are treated against the lettuce root aphid Pemphigus bursarius. Here, the active compound Example (I-4) (240 SC) is applied with a knapsack sprayer operated by pressurized air at the beginning of the infestation at the stated application rates to the above-ground parts of the plants. The soil is covered with a film. The application rate is 600 l of water/ha. 0.1% a.i. of rapeseed oil methyl ester (500 EW) is added to the spray liquor. Omethoate as drip irrigation in a concentration of 0.1% is used for comparison. The application is carried out two days later.

The kill in percent is determined on the roots. After 9 and 17 days, the following kills are obtained:

| Active | | | |
|---|---|---|---|
| compound | Application rate | Kill (%) | |
| Example (I-4) | 96 g of a.i./ha | 46.9 (9 d) | 80.4 (17 d) |
| omethoate | drip irrigation 0.1% | 20 (7 d) | 70.6 (15 d) |

### Phylloxerans (Phylloxeridae)

Very particular preference is given to controlling the following species from the family of the phylloxerans (Phylloxeridae), preferably after foliar application:
Phylloxera devastatrix in grapevines, in nuts, such as, for example, pecan nuts,
Phylloxera vastatrix, (\hat{=}Viteus vitifolii) in grapevines.

### Example 4

In four replications, three in each case about 12-year-old vines of the cultivar “Auvemat” are treated against Viteus vitifolii. As commercial standard, imidacloprid is used at the recommended application rate by drip irrigation. The application of the active compounds is by spray application to the leaves using a knapsack operated with pressurized air. Here, the active compounds Example (I-4) (240 SC) and Example (I-9) (240 SC) are applied in a tank mix with 0.1% a.i. of rapeseed oil methyl ester (500 EW) at the stated amount. There are three applications on day 1, 2 and 15. The application rate is 1776 l of water/ha.

Evaluation is carried out 60 days after the last treatment by rating the kill on the roots in percent.

| Active | | |
|---|---|---|
| compound | Application rate a.i. | Kill (%) |
| imidacloprid | drip irrigation | 26 |
| | 560 g/ha | |
| Example (I-4) | 0.0168% | 55 |
| Example (I-9) | 0.0144% | 42 |

### Jumping Plant Lice (Psyllidae)

Very particular preference is given to controlling the following species from the family of the jumping plant lice (Psyllidae):
Psylla pyricola in pomme fruit, such as, for example, pears, apples, in stone fruit, such as, for example, cherries, plums, garden plums, peaches, nectarines,
Psylla piri in pomme fruit, such as, for example, pears,
Psylla pyrisuga in pomme fruit, such as, for example, pears,
Psylla costalis in pomme fruit, such as, for example, apples,
Paratrioza cockerelli in fruit vegetables, such as, for example, tomatoes, bell peppers, chilli peppers, in root vegetables, such as, for example, carrots, in potatoes,
Tenalaphara malayensisin tropical crops, such as, for example, durians,
Diaphorina citri in citrus fruit, such as, for example, oranges, mandarins, limes, grapefruits,
Trioza erythrae in citrus fruits, such as, for example, oranges, grapefruits.

### Example 5

In three replications, pear trees of the cultivar “Williams Christ” are treated against Psylla piri. Application is shortly before the eggs hatch. The application is carried out using a barrow-mounted sprayer operated with pressurized air. Here, the active compound Example (I-4) (240 SC) is tested in a tank mix with 0.1% a.i. rapeseed oil methyl ester (500 EW) at the stated amount against the standard amitraz (200 EC) at the stated amount. The application rate is 1000 l of water/ha.

Evaluation is carried out 7, 14 and 21 days after the treatment by rating the kill of the nymphs on the shoots.

### Example 6

In three replications, in each case 4 about 4-year-old pear trees of the cultivar “Williams Christ” are treated against Psylla piri. Two applications are carried out at an interval of 11 days using a motor-operated barrow-mounted sprayer. Here, the active compounds Example (I-9) (240 SC), Example (I-2) (240 SC) and Example (I-1) (240 SC) are tested against the commercial standard Amitraz (200 EC) at the stated amounts. The application rate is 2000 l of water/ha.

Evaluation is carried out 3, 10 and 20 days after the last treatment by rating the kill of the larvae in percent on the shoots.

| Active | | Kill (%) | | |
|---|---|---|---|---|
| compound | Application rate (%) of a.i. | 3 d | 10 d | 20 d |
| amitraz | 0.05 | 54.3 | 56.7 | 21.4 |
| Example (I-9) | 0.096 | 97.7 | 100 | 100 |
| Example (I-2) | 0.096 | 96.7 | 99 | 97.9 |
| Example (I-1) | 0.096 | 90.0 | 96.6 | 95.0 |

### Example 7

In four replications, plots of a size of about 7 m² with bell peppers of the cultivar “Jupiter” are treated against Paratrioza cockerelli. The application is carried out with a knapsack sprayer operated with pressurized air. Here, the active compound Example (I-4) (240 SC) is applied in a tank mix with 0.2% a.i. of rapeseed oil methyl ester (500 EW) and the commercial standards imidacloprid 192 SC and dimethoate (480 EC) are applied in a tank mix with 0.125% Induce at the stated application rates. The application is carried out with an application rate of 467 l of water/ha.

Evaluation is carried out 7 and 15 days after the treatment by rating the kill of the animals (nymphs) on the leaves.

| | | |
|---|---|---|
| Active | Application | Kill (%) |

| compound | rate g of a.i./ha | 7 d | 15 d |
|---|---|---|---|
| Imidacloprid | 52.6 | 90 | 0 |
| Example (I-4) | 72 | 90 | 100 |
| dimethoate | 561 | 63 | 0 |

### Example 8

In three replications, about 2-year-old orange trees are treated against Trioza erythreae. The application is carried out using a knapsack sprayer operated with pressurized air. Here, the active compound Example (I-4) (240 SC) is tested in a tank mix with 0.2% a.i. of rapeseed oil methyl ester (500 EW) against the commercial standard imidacloprid (100 SL) at the stated application rates. The application rate is 540 l of water/ha. Two treatments are carried out, at an interval of 7 days.

Evaluation is carried out 7, 14 and 20 days after the first treatment by rating the kill of the nymphs on the branches.

| Active | Application | Kill (%) | | |
|---|---|---|---|---|
| compound | rate (%) | 7 d | 14 d | 20 d |
| imidacloprid | 0.004 | 98.4 | 99.2 | 98.6 |
| Example (I-4) | 0.0144 | 97.9 | 98.9 | 98.3 |

### Example 9

In three replications, plots of a size of 10 m² with tomatoes are treated against Paratrioza cockerelli. Application is carried out using a knapsack sprayer operated with pressurized air. Here, the active compound Example (I-4) (240 SC) in a tank mix with 0.2% a.i. of rapeseed oil methyl ester (500 EW) and the commercial standard Leverage (324 SE) are tested at the stated application rates. There are two applications at an interval of 7 days. The application rate is 345 l of water/ha.

Evaluation is carried out 7, 14 and 21 days after the first treatment by rating the kill of the animals (nymphs) on the leaves.

| | Application | | | |
|---|---|---|---|---|
| Active | rate g of | Kill (%) | | |
| compound | a.i./ha | 7 d | 14 d | 21 d |
| Levarage | 81 | 75.4 | 81.1 | 92.1 |
| Example (I-4) | 48 | 71.3 | 90.3 | 95.5 |

### Soft Scales (Coccidae)

Very particular preference is given to controlling the following species from the family of the soft scales (Coccidae) in the following crops, preferably after foliar application:
Ceroplastes ceriferus in citrus fruit, such as, for example, oranges, grapefruits,
Ceroplastes floridensis mandarins, lemons, limes, satsumas
Ceroplastes rubens
Ceroplastes rusci
Drosicha mangiferae in tropical crops, for example mangoes
Drosicha stebbengii
Pulvinaria aurantii in citrus fruit, such as, for example, oranges, grapefruits,
Pulvinaria aethiopicus mandarins, lemons, limes, satsumas, in grapevines
Pulvinaria vitis
Protopulminaria in pomme fruit and stone fruit
pyriformis
Saissetia oleae in citrus fruit, such as, for example, oranges, grapefruits, mandarins, limes
Saissetia nigra in citrus fruit, such as, for example, lemons, satsumas, in olives, in tropical crops, for example bananas
Coccus viridis in citrus fruit, such as, for example, oranges, mandarins, grapefruits, limes, lemons, satsumas, in tropical crops, for example pineapples
Coccus hesperdium in pomme fruit, such as, for example, apples, pears, in stone fruit, such as, for example, peaches, nectarines, plums, apricots, cherries, in coffee, in olives, in tea, in vegetables, such as, for example, beans, in grapevines

### Example 10

In three replications, about 6-year-old mandarin trees of the cultivar “Naartje” are treated against Pulvinaria aethiopicus. Two applications are carried out at an interval of 32 days as irradication treatment using a knapsack operated with pressurized air. Here, the active compounds Example (I-9) (240 SC) and Example (I-2) (240 SC) are tested against a commercial tank mix of a mineral oil (835 EC) which is commercially available in South Africa and customarily used in this country and pyriproxifen (100 EC) at the stated amounts. The application rate is 8.3 l of water/tree.

Evaluation is carried out 45 days after the last treatment by rating the kill in percent on the fruits.

| | Application rate (%) | |
|---|---|---|
| Active compound | of a.i. | Kill (%) |
| Mineral oil + | 0.251 | 90 |
| pyriproxifen | 0.003 | |
| Example (I-9) | 0.0096 | 91 |
| Example (I-2) | 0.0144 | 72 |

### Example 11

In three replications, in each case one about 4-year-old satsuma tree of the cultivar “Nankan 20” is treated against Pulvinaria aurantii. Here, the active compound Example (I-4) (240 SC) in a tank mix with 0.2% of rapeseed oil methyl ester (500 EW) at the stated application rate is tested against the commercial standard buprofezin at the stated application rate. The application is carried out using a motor-operated knapsack sprayer. Here, each plant is treated with 400 ml of spray liquor.

Evaluation is carried out before and 41 days after the treatment by counting the live animals. The efficacy in percent is then calculated according to Henderson and Tilton.

| Active | Application | |
|---|---|---|
| compound | rate (%) of a.i. | Effect (%) |
| buprofezin | 0.025 | 68 |
| Example (I-4) | 0.0144 | 100 |

### Example 12

In three replications, in each case one about 4-year-old satsuma tree of the cultivar “Nankan 20” is treated against Ceroplastes rubens. Here, the active compound Example (I-4) (240 SC) in a tank mix with 0.1% of rapeseed oil methyl ester (500 EW) at the stated application rate is tested against the commercial standard buprofezin (25 WP) at the stated application rate. The application is carried out using a motor-operated knapsack sprayer. Here, treatment is carried out using an application rate of 400 l of water/ha.

Evaluation is carried out before and 41 days after the treatment by counting the live animals. The efficacy in percent is then calculated according to Henderson and Tilton.

| Active | Application | |
|---|---|---|
| compound | rate (%) of a.i. | Effect (%) |
| buprofezin | 0.025 | 50 |
| Example (I-4) | 0.0072 | 98 |

### Example 13

In three replications, in each case two about 8-year-old orange trees are treated against Saissetia oleae. Here, the active compounds Example (I-4) (240 SC) and Example (I-8) (250 SC) in a tank mix with 0.2% a.i. of rapeseed oil methyl ester (500 EW) at the stated application rate are tested against the commercial standard buprofezin in a tank mix with 0.4% a.i. of Oliocin (800 EW) at the stated application rate. The application is carried out using a motor-operated knapsack sprayer. The application rate is 3000 l of water/ha. Two treatments are carried out, at an interval of 29 days.

Evaluation is carried out 24 and 44 days after the last treatment by rating the kill of the nymphs on the leaves.

| | |
|---|---|
| Application rate g of a.i./ | Kill (%) |

| Active compound | ha/height of crown in m | 24 d | 44 d |
|---|---|---|---|
| buprofezin | 500 | 33.5 | 50.5 |
| Example (I-4) | 72 | 53.5 | 56.1 |
| Example (I-8) | 30 | 66.5 | 56.1 |

### Example 14

In three replications, orange trees of the cultivar “Navelina” are treated against Saissetia oleae. Here, the active compounds Example (I-4) (240 SC) and Example (I-9) (240 SC) in a tank mix with 0.1% of rapeseed oil methyl ester (500 EW) at the stated application rate are tested against the commercial standards Dursban (480 EC) and pyriproxyfen (100 EC) at the stated application rate. The application is carried out using a motor-operated knapsack sprayer. The application rate is 3200 l of water/ha.

Evaluation is carried out 120 days after the treatment by rating the kill of the animals on the branches.

| Active | Application | Effect (%) |
|---|---|---|
| compound | rate (%) of a.i. | 120 d |
| Dursban | 0.096 | 0 |
| Example (I-4) | 0.012 | 98 |
| Example (I-9) | 0.0054 | 79 |
| pyriproxyfen | 0.005 | 100 |

### Armoured Scales (Diaspididae)

Very particular preference is given to controlling the following species from the family of the armoured scales (Diaspididae) in the following crops, preferably after foliar application:
Quadraspidiotus in citrus fruit, such as, for example, oranges, mandarins, limes,
perniciosus grapefruits, in pomme fruit, such as, for example, apples, pears,
Quadraspidiotus quince, in stone fruit, such as, for example, peaches, nectarines,
juglansregiae apricots, plums, cherries, in nuts, such as, for example, almonds, pistachios, walnuts, hazelnuts, in ornamental plants, such as, for example, shrubs, conifers, potted plants, in tropical crops, for example litchis,
Aonidiella aurantii in citrus fruit, such as, for example, oranges, mandarins,
Aonidiella citrina grapefruits, limes, lemons, satsumas,
Lepidosaphes ulmi in citrus fruit, such as, for example, oranges, mandarins,
Lepidosaphes beckii grapefruits, limes, lemons, satsumas, in pomme fruit, such as, for example, apples and pears, in stone fruit, such as, for example, peaches, nectarines, plums, apricots, cherries,
Aspidiotus in citrus fruit, such as, for example, oranges, mandarins,
destructor grapefruits, limes, lemons, satsumas, in ornamental plants, such as,
Aspidiotus hederae for example, shrubs, potted plants, in olives, in tropical crops, for
Aspidiotus nerii example mangoes, limes,
Aspidiotus ficus
Pseudaulacaspis in pomme fruit, such as, for example, apples, pears, in stone fruit,
pentagona such as, for example, peaches, apricots, nectarines, cherries, plums, garden plums, in tea,
Unaspis yanonensis in citrus fruit, such as, for example, oranges, mandarins, limes,
Unaspis citri grapefruits, lemons, satsumas, in tropical crops, for example pineapples, mangoes,
Pinnaspis aspidistrae
Parlatoria ziziphus in citrus fruit, such as, for example, oranges, mandarins, limes,
Parlatoria pergandei lemons, satsumas, grapefruits, in olives,
Parlatoria oleae
Selenaspidus in citrus fruit, such as, for example, oranges, mandarins, limes,
articulatus grapefruits, lemons, satsumas

### Example 15

In three replications, 3-year-old orange trees of the cultivar “Midnight Valenzia” are treated against Aonidiella aurantii. Two applications are carried out at an interval of 72 days, using a motor-operated knapsack sprayer. Here, the active compounds Example (I-9) (240 SC) and Example (I-2) (240 SC) in a tank mix with 0.1% a.i. of rapeseed oil methyl ester (500 EW) at the stated application rate are tested against the standard Tokuthion (960 EC) at the stated amounts. applied once. The application rate is 4 l of water per tree.

Evaluation is carried out 130 and 176 days after the treatment by rating the kill on the fruits.

| | | |
|---|---|---|
| Active | Application | Kill (%) |

| compound | rate (%) of a.i. | 130 d | 176 d |
|---|---|---|---|
| Tokuthion | 0.048 | 12 | 0 |
| Example (I-9) | 0.0096 | 86 | 100 |
| Example (I-2) | 0.0096 | 52 | 76 |

### Example 16

In four replications, an about 10-year-old grapefruit tree of the cultivar “Rio Red” is treated against Aonidiella aurantii. The application is carried out using a motor-operated barrow-mounted sprayer. Here, the active compound Example (I-4) (240 SC) and the commercial standard Dursban (480 EC) are tested at the stated application rates. The amount of spray liquor is 5.8 gallons per tree.

Evaluation is carried out 28, 59 and 90 days after the treatment by rating the kill of the animals on the fruits.

| | Application rate | | | |
|---|---|---|---|---|
| Active | per metre of | Kill (%) | | |
| compound | crown height a.i. | 28 d | 59 d | 90 d |
| Dursban | 6.01 pounds/acre | 100 | 100 | 100 |
| Example (I-4) | 72 g/ha | 92.7 | 100 | 100 |

### Example 17

In three replications, four about 18-year-old apple trees of the cultivar “Red Chief” are treated against the San Jose scale louse Quadraspidiotus perniciosus. Two applications are carried out at an interval of 15 days using a motor-operated barrow-mounted sprayer. Here, the active compound Example (I-4) (240 SC) is applied in a tank mix with 0.2% a.i. of rapeseed oil methyl ester (500 EW) at the stated application rate and the commercial standard Dursban (446 EC) is applied at the stated application rate. The application rate is 1500 l of water/ha.

Evaluation is carried out 43 days after the last treatment by rating the kill on the shoots.

| | Application rate | |
|---|---|---|
| Active | g of a.i./ha/ | |
| compound | crown height in m | Kill (%) |
| Dursban | 223 | 68.3 |
| Example (I-4) | 72 | 90.4 |

### Example 18

In three replications, in plots of a size of about 20 m², citrus trees of the cultivar “Oro Nules” are treated against Lepidosaphes beckii. The application is carried out using a high-pressure sprayer. Here, the active compound Example (I-4) (240 SC) in a tank mix with 0.1% a.i. of rapeseed oil methyl ester (500 EW) is tested against the commercial standard pyriproxyfen (100 EC), at the stated application rates. The application rate is 2500 l of water/ha.

Evaluation is carried out 140 days after the treatment by rating the kill of the larvae on the fruits.

| | Application rate | |
|---|---|---|
| Active | g of a.i./ha/ | Kill (%) |
| compound | crown height in m | 140 days |
| pyriproxyfen | 50 | 100 |
| Example (I-4) | 48 | 100 |

### Example 18a

The evaluation for Example 18a against Parlatoria pergandei is carried out as part of the test as described in Example 27 and is listed separately in Example 27.

### Example 19

In three replications, 3-year-old orange trees of the cultivar “Pera natal” are treated against Selenaspidius articulatus. The application is carried out using a motor-operated knapsack sprayer. Here, the active compounds Example (I-9) (240 SC) and Example (I-4) (240 SC) at the stated application rate are tested against the standard methidathion (400 EC) in the stated amounts, applied once. The application rate is 3.3 l of water per tree.

Evaluation is carried out 100 days after the treatment by rating the kill on the leaves.

| Active | Application rate | Kill (%) |
|---|---|---|
| compound | (%) of a.i. | 100 d |
| methidathion | 0.05 | 77 |
| Example (I-9) | 0.0288 | 77 |
| Example (I-4) | 0.0144 | 70 |

### Example 20

In four replications, about 5-year-old lime trees of the cultivar “Fino” are treated against Aspidiotus neri. The application is carried out using a knapsack sprayer. Here, the active compound Example (I-4) (240 SC) in a tank mix with 0.1% a.i. of rapeseed oil methyl ester (500 EW) at the stated application rate is tested against the standards Dursban (480 EC) and Juvinal (100 EC) at the stated amounts, applied once. The application rate is 3000 l of water/ha per tree.

Evaluation is carried out 167 days after the treatment by rating the kill on the fruits.

| Active | Application rate | Kill (%) |
|---|---|---|
| compound | (%) of a.i. | 167 d |
| Dursban | 0.096 | 76.9 |
| Juvinal | 0.005 | 86.5 |
| Example (I-4) | 0.0072 | 96.2 |

### Example 21

In four replications, an about 20-year-old almond tree of the cultivar “Non-Pareil” is treated against Quadraspidiotus perniciosus. The application is carried out using a high-pressure sprayer. Here, the active compound Example (I-4) (240 SC) in a tank mix with 0.125% a.i. of methylated seed oil (1000 EC) and the commercial standard Lorsban (480 EC) are tested at the stated application rates. The amount of spray liquor is 935 l/ha.

Evaluation is carried out 21, 42 and 63 days after the treatment by rating the kill of the animals on the branches.

| | Application rate | | | |
|---|---|---|---|---|
| Active | per metre of | Kill (%) | | |
| compound | crown height a.i. | 21 d | 42 d | 63 d |
| Dursban | 2240 g/ha | 82.2 | 73.3 | 78.4 |
| Example (I-4) | 110 g/ha | 84.9 | 90 | 94.6 |

### Example 22

In ten replications, on about 46 m², peach trees are treated against Pseudaulacaspis pentagons. Two applications are carried out at an interval of 57 days using a sprayer operated with pressurized air. Here, the active compound Example (I-4) (240 SC) in a tank mix with 0.2% of Dynamic (910 XL) is applied at the stated application rate and the commercial standard Esteem (35 WP) is applied at the stated application rate. The application rate is 935 l of water/ha.

Evaluation is carried out 35 and 79 days after the last treatment by rating the kill of the crawlers on the shoots.

| | Application rate | | |
|---|---|---|---|
| Active | g of a.i./ha/height | Kill (%) | |
| compound | of crown in m | 35 d | 79 d |
| Esteem | 98 | 98 | 94 |
| Example (I-4) | 120 | 90 | 87 |

### Example 23

In six replications, about 16-year-old Japanese apricot trees of the cultivar “Shirokag” are treated against Pseudaulacaspis prunicola. The application is carried out using a sprayer. Here, the active compound Example (I-4) (200 SC) is tested against the commercial standard Supracide EC (400 EC), at the stated application rates. The application rate is 1500 l of water/ha.

Evaluation is carried out 58 days after the treatment by rating the kill of the nymphs on the shoots.

| Active | Application | Kill (%) |
|---|---|---|
| compound | rate (%) of a.i. | 58 days |
| Supracide EC | 0.04 | 91.6 |
| Example (I-4) | 0.0075 | 92.3 |

### Example 24

In nine replications, about 7-week-old tea plants of the cultivar “Yakubita” are treated against Pseudaulacaspis pentagona. Here, the active compound Example (I-4) (200 SC) is tested against the commercial standard Supracide EC (400 EC) at the stated application rates. The application is carried out using a sprayer operated with pressurized air. Evaluation is carried out 16 and 35 days after the treatment by rating the kill of the crawlers on the plants.

| | | |
|---|---|---|
| Active | Application | Kill (%) |

| compound | rate (%) of a.i. | 16 d | 35 d |
|---|---|---|---|
| Supracide EC | 0.04 | 60.3 | 100 |
| Example (I-4) | 0.01 | 81.8 | 75 |

### Ensign Coccids (Ortheziidae)

Very particular preference is given to controlling the following species from the family of the ensign coccids (Ortheziidae) in the following crops, preferably after foliar application:
Orthezia praelonga in citrus fruit, such as, for example, oranges, mandarins, limes, grapefruits, lemons, satsumas

### Example 25

In two replications, two about 7-year-old orange trees of the cultivar “Pera Rio” are treated against Orthezia praelonga. Here, the active compounds Example (I-4) (240 SC) and Example (I-9) (240 SC), in a tank mix with 0.1% a.i. of Renex, are tested against the commercial standard Methidathion (400 EC), at the stated application rates. The application is carried out using a knapsack sprayer operated with pressurized air. Evaluation is carried out 6 and 16 days after the treatment by rating the kill of the population on the leaves.

| | |
|---|---|
| Active | Kill (%) |

| compound | Application rate (%) of a.i. | 6 d | 16 d |
|---|---|---|---|
| methidathion | 0.05 | 91 | 61 |
| Example (I-4) | 0.0144 | 94 | 76 |
| Example (I-9) | 0.0144 | 89 | 63 |

### Mealy Bugs (Pseudococcidae)

Very particular preference is given to controlling the following species from the family of the mealy bugs (Pseudococcidae) in the following crops:
Pseudococcus citri in citrus fruit, such as, for example, oranges, mandarins,
Pseudococcus comstocki grapefruits, limes, lemons, satsumas, in pomme fruit, such as,
Pseudococcus maritimus for example, apples and pears, in grapevines, in ornamental plants, in tropical crops, such as, for example, pineapple
Dysmicoccus boninsis in pomme fruit, such as, for example, apples, pears, in tea, in
Dysmicoccus cryptus tropical crops, such as, for example, pineapples, guyabano
Dysmicoccus brevipes
Planococcus lilacinus in citrus fruit, such as, for example, oranges, mandarins,
Planococcus citri grapefruits, limes, lemons, satsumas, in grapevines
Pericerga purchasi in citrus fruit, such as, for example, oranges, mandarins, grapefruits, limes, lemons, satsumas

### Example 26

In three replications, in plots of a size of about 20 m², citrus trees of the cultivar “Oro Nules” are treated against Pseudococcus citri. The application is carried out using a high-pressure sprayer. Here, the active compound Example (I-4) (240 SC), in a tank mix with 0.1% a.i. of rapeseed oil methyl ester (500 EW), is tested against the commercial standard Dursban (480 EC), at the stated application rates. The application rate is 2500 l of water/ha.

Evaluation is carried out 62 days after the treatment by rating the kill of the larvae on the fruits.

| | Application rate | Kill (%) |
|---|---|---|
| Active compound | g of a.i./ha/crown height in m | 62 days |
| Dursban | 960 | 100 |
| Example (I-4) | 72 | 99 |

### Example 27

In three replications, orange trees of the cultivar “Navelina” are treated against Parlatoria pergandei and Pseudococcus citri. Two applications are carried out at an interval of 77 days using a motor-operated knapsack sprayer. Here, the active compound Example (I-9) (240 SC), in a tank mix with 0.1% a.i. of rapeseed oil methyl ester (500 EW), at the stated amount, is tested against the commercial standard pyriproxyfen (100 EC), at the stated amounts. The application rate is 3000 l of water/ha.

Evaluation is carried out 56 days or 73 days after the last treatment by rating the kill in percent on the fruits.

### Parlatoria Pergandei (Example 18a)

| Active | | Kill (%) |
|---|---|---|
| compound | Application rate (%) of a.i. | 73 d |
| pyriproxyfen | 0.005 | 97.5 |
| Example (I-9) | 0.0096 | 98.7 |

Pseudococcus citri

| Active | | Kill (%) |
|---|---|---|
| compound | Application rate (%) of a.i. | 56 d |
| pyriproxyfen | 0.005 | 28.8 |
| Example (I-9) | 0.0096 | 94.6 |

### Example 28

In four replications, three in each case about 12-year-old vines of the cultivar “Auvemat” are treated against Pseudococcus spp. The commercial standard used is an application with imidacloprid at the recommended application rate, by drip irrigation. The active compounds are applied by spraying using a knapsack sprayer operated with pressurized air. Here, the active compounds Example (I-4) (240 SC) and Example (I-9) (240 SC) are applied in a tank mix with 0.1% a.i. of rapeseed oil methyl ester (500 EW), at the stated amount. Two applications are carried out at an interval of 15 days. The application rate is 1776 l of water/ha. Evaluation is carried out 28 days after the last treatment by rating the kill on grapes in percent.

| Active | | |
|---|---|---|
| compound | Application rate of a.i. | Kill (%) |
| imidacloprid | drip irrigation 560 g/ha | 100 |
| Example (I-4) | 0.0168% | 99 |
| Example (I-9) | 0.0144% | 100 |

### Example 29

In three replications, in plots of a size of 54 m², about 10-year-old vines of the cultivar “Napoleon” are treated against Planococcus spp. The application is carried out using a knapsack sprayer. Here, the active compound Example (I-4) (240 SC), in a tank mix with 0.1% a.i. of rapeseed oil methyl ester (500 EW), is tested against the commercial standard Dursban (480 EC), at the stated application rates. The application rate is 864 l of water/ha. Two treatments are carried out, at an interval of 19 days.

Evaluation is carried out 16 and 38 days after the second treatment by rating the kill of the larvae on the grapes.

| | |
|---|---|
| Active | Kill (%) |

| compound | Application rate %/1 | 16 d | 38 d |
|---|---|---|---|
| Dursban | 0.096 | 72.2 | 64 |
| Example (I-4) | 0.0096 | 94.4 | 91.9 |

### Example 30

In five replications, pineapple plants of the cultivar “MD2” of a height of about 35 cm are treated against Dysmicoccus brevipes. The application is carried out using a motor-operated knapsack sprayer. Here, the active compound Example (I-4) (150 OD) is tested against the commercial standard Confidor OD (240 OD), at the stated application rates. The application rate is 4000 l of water/ha. Both active compounds are sprayed as a tank mix with 500 g of a.i./ha of adjuvant NP-7 and 4 l of a.i./ha of mineral oil.

Evaluation is carried out 9, 23 and 37 days after the treatment by rating the kill of the nymphs on the plants.

| Active | Application rate | Kill (%) | | |
|---|---|---|---|---|
| compound | g of a.i./ha | 9 days | 23 days | 37 days |
| Confidor OD | 140 | 93.9 | 98.6 | 76.8 |
| Example (I-4) | 75 | 80.9 | 84.0 | 91.3 |

### Example 30a

In three replications, in each case one guyabano tree is treated against Dysmicoceus brevipes. Here, the active compound Example (I-4) (240 SC), in a tank mix with 0.1% of rapeseed oil methyl ester (500 EW), is, at the stated application rate, tested against the commercial standard Lorsban (500 EC), at the stated application rate. The application is carried out using a motor-operated knapsack sprayer. Here, each plant is treated with spray liquor.

Evaluation is carried out 3, 7 and 14 days after the treatment by rating the kill in percent on the fruits.

| Active | Application rate (g) | Kill (%) | | |
|---|---|---|---|---|
| compound | of a.i./crown height in m | 3 days | 7 days | 14 days |
| Lorsban | 180 | 78.3 | 94.7 | 100 |
| Example (I-4) | 48 | 89.8 | 100 | 100 |

### Whiteflies (Aleyrodidae)

Very particular preference is furthermore given to controlling the following species from the family of the whiteflies (Aleyrodidae), in the following crops:
Bemisia tabaci in vegetables, such as bell peppers, tomatoes, cucumbers, cabbage, for example broccoli, beans, lettuce, aubergines, courgettes, cucurbits, in soft fruits, in melons, for example watermelons, net melons, cantaloupe melons, in ornamental plants, such as roses, hibiscus, in citrus fruit, such as oranges, mandarins, grapefruits, and also in potatoes, in tobacco and in tropical crops, such as, for example, papayas, bananas,
Bemisia argentifolii in cotton, in vegetables, such as bell peppers, tomatoes, cucumbers, beans, cucurbits, aubergines, courgettes, cabbage, in soft fruit, in melons, for example watermelons, net melons, cantaloupe melons, in ornamental plants, such as, for example, roses, hibiscus, in tropical crops, such as, for example, papayas, bananas,
Trialeurodes in vegetables, such as tomatoes, bell peppers, beans,
vaporariorum cucumbers, cucurbits, aubergines, in soft fruit, in melons and also in ornamental plants, such as, for example roses, hibiscus,
Aleurothrixus floccosus in citrus fruit, such as, for example, oranges, mandarins, lemons
Aleurodes citri in citrus fruit, such as oranges, mandarins, lemons, grapefruits, limes, cumquats
Aleurodes fragriae in soft fruit, such as, for example, strawberries
Aleurodes azaleae in ornamental plants, such as, for example, azalea

### Example 31

In four replications, in each case one orange tree of the cultivar “Newhall” is treated against Aleurodes citri. Here, the active compound Example (I-4) (240 SC) is, at the stated application rate, tested against the commercial standard imidacloprid. The active compounds are applied in a tank mix with 0.5% a.i. of Oliocin (700 EW), at an application rate of 1500 l of water/ha. The application is carried out using a motor-operated knapsack sprayer.

Evaluation is carried out 7, 14 and 21 days after the treatment by rating the kill of the animals on the leaves.

| Active | Application rate | Kill (%) | | |
|---|---|---|---|---|
| compound | g of a.i./ha/crown height in m | 7 d | 14 d | 21 d |
| imidacloprid | 75 | 98.4 | 99.6 | 99.4 |
| Example (I-4) | 72 | 90.9 | 99.5 | 99.9 |

### Example 32

In three replications, plots of a size of 10 m² with bell peppers of the cultivar “Italiano” are treated against Bemisia tabaci. The application is carried out using a motor-operated knapsack sprayer. Here, the active compounds Example (I-9) (240 SC), Example (I-2) (60 SC) and Example (I-11) (60 SC) and the commercial standard imidacloprid (200 SL) are applied at the stated application rates. Three applications at an interval of 14 or 15 days are carried out, at an application rate of 1000 or 1100 l of water/ha.

Evaluation is carried out 7, 14 and 22 days after the second treatment by rating the kill of the animals (larvae) on the leaves.

| Active | | Kill (%) | | |
|---|---|---|---|---|
| compound | Application rate % of a.i. | 7 d | 14 d | 22 d |
| imidacloprid | 0.02 | 75.8 | 67.2 | 69.4 |
| Example (I-9) | 0.0144 | 90.4 | 95.1 | 92.6 |
| Example (I-2) | 0.0144 | 84.7 | 92.6 | 85.6 |
| Example(I-11) | 0.0144 | 85.4 | 93.3 | 91.3 |

### Example 33

In four replications, plots of a size of 26 m² with cucumbers of the cultivar “Beta alpha” are treated against Bemisia tabaci. The application is carried out using a knapsack sprayer operated with pressurized air. Here, the active compound Example (I-4) (240 SC), in a tank mix with 0.1% a.i. of rapeseed oil methyl ester (500 EW), and the commercial standard imidacloprid (200 SC) are tested at the stated application rates. Two applications are carried out, at an interval of 10 days. The application rate is 1000 l of water/ha.

Evaluation is carried out 7, 11 and 21 days after the first treatment by rating the kill of the animals (nymphs) on leaves.

| Active | | Kill (%) | | |
|---|---|---|---|---|
| compound | Application rate % of a.i. | 7 d | 11 d | 21 d |
| imidacloprid | 0.144 | 89 | 96 | 96 |
| Example (I-4) | 0.084 | 75 | 87 | 90 |

### Example 34

In three replications, plots of a size of 5 m² with tomatoes of the cultivar “Rio Grande” are treated against Trialeurodes vaporariorum. The application is carried out using a motor-operated knapsack apparatus. Here, the active compounds Example (I-9) (240 SC) and Example (I-4) (240 SC) and the commercial standard imidacloprid (200 SL) are tested at the stated application rates. The application rate is 1000 l of water/ha. Three applications are carried out, at an interval of 11 or 10 days.

Evaluation is in each case carried out 7 or 10 days after each treatment, by rating the kill of the larvae on the leaves.

| | Application rate % of | | | |
|---|---|---|---|---|
| | a.i. | | Kill (%) | |
| | | 10 d | 7 d | 10 d |
| Active | | after the 1st | after the 2nd | after the 3rd |
| compound | | treatment | treatment | treatment |
| imidacloprid | 0.015 | 53.5 | 88.4 | 67.5 |
| Example (I-9) | 0.0144 | 63.3 | 99.6 | 94.3 |
| Example (I-4) | 0.0144 | 81.9 | 100 | 94.3 |

### Example 35

In three replications, plots of a size of 10 m² with aubergines of the cultivar “F 100” are treated against Bemisia argentifolii. The application is carried out using a knapsack sprayer operated with pressurized air. Here, the active compounds Example (I-9) (60 SC), Example (I-2) (60 SC) and Example (I-11) (60 SC) and the commercial standard imidacloprid (70 WG) are tested at the stated application rates. Three applications are carried out, at an interval or 7 or 8 days. The application rate is 1000 l of water/ha.

Evaluation is carried out 7 days after the last treatment by rating the kill of the nymphs on the leaves.

| Active | Application rate % of | Kill (%) |
|---|---|---|
| compound | a.i. | 7 d |
| imidacloprid | 0.014 | 100 |
| Example (I-9) | 0.0144 | 98 |
| Example (I-2) | 0.0144 | 100 |
| Example (I-11) | 0.0144 | 94 |

### Example 36

In three replications, in each case four aubergine plants of the cultivar “Ryoma” are treated against Bemisia argentifolii. The application is carried out using a motor-operated knapsack sprayer. Here, the active compounds Example (I-4) and Example (I-8), in a tank mix with 0.2% a.i. of rapeseed oil methyl ester (500 EW), and the commercial standard pymetrozine (25 WP) are tested at the stated application rates. The application rate is 3200 l of water/ha.

Evaluation is carried out 13, 20 and 27 days after the treatment by rating the kill of the nymphs on the leaves.

| Active | | Kill (%) | | |
|---|---|---|---|---|
| compound | Application rate % of a.i. | 13 d | 20 d | 27 d |
| pymetrozine | 0.0125 | 79 | 74 | 75 |
| Example (I-4) | 0.072 | 99.6 | 100 | 97 |
| Example (I-8) | 0.06 | 99.5 | 99.9 | 97 |

### Example 37

In four replications, plots of a size of about 39 m² with cantaloupe melons of the cultivar “Western Shipper” are treated against Bemisia argentifolii. The application is carried out using a knapsack sprayer operated with pressurized air. Here, the active compound Example (I-4) (240 SC), in a tank mix with 0.2 a.i. of rapeseed oil methyl ester (500 EW), and the commercial standard endosulfan (360 EC) are tested at the stated application rates. Two applications are carried out at an interval of 16 days. The application rate is 187 l of water/ha.

Evaluation is carried out 5, 13, 21 and 29 days after the first treatment by rating the kill of the animals (nymphs) on the leaves.

| Active | Application rate g of | Kill (%) | | | |
|---|---|---|---|---|---|
| compound | a.i./ha | 5 d | 13 d | 21 d | 29 d |
| endosulfan | 1120 | 0 | 100 | 80.8 | 66.7 |
| Example (I-4) | 48 | 100 | 100 | 98.1 | 90.5 |

### Example 38

In three replications, plots of a size of about 7.5 m² with melons of the cultivar “Piel DE Sapo” are treated against Bemisia tabaci. The application is carried out with a motor-operated knapsack sprayer. Here, the active compound Example (I-4) (240 SC), in a tank mix with 0.1% of a.i. of rapeseed oil methyl ester (500 EW), and the commercial standard Confidor (200 SL) are applied at the stated application rates. Two applications are carried out, at an interval of 7 days and at an application rate of 233 l of water/ha.

Evaluation is carried out 7 and 15 days after the second treatment by rating the kill of the animals (nymphs) on the leaves.

| | |
|---|---|
| Active | Kill (%) |

| compound | Application rate g of a.i./ha | 7 d | 15 d |
|---|---|---|---|
| Confidor | 100 | 98.8 | 75.7 |
| Example (I-4) | 72 | 85.3 | 95.5 |

### Example 39

In three replications, about 55-year-old orange trees of the cultivar “Amargo” are treated against Aleurothrixus floccosus. The application is carried out using a motor-operated knapsack sprayer. Here, the active compound Example (I-4) (240 SC), in a tank mix with 0.1% a.i. of rapeseed oil methyl ester (500 EW), is tested at the stated application rate against the standard Juvinal (100 EC) at the stated application rates, applied once. The application rate is 2630 l of water/ha.

Evaluation is carried out 36, 51, 62 and 76 days after the treatment by rating the kill on the branches.

| Active | Application rate | Kill (%) | | | |
|---|---|---|---|---|---|
| compound | % of a.i. | 36 d | 51 d | 62 d | 76 d |
| Juvinal | 0.005 | 57.8 | 60.7 | 73.1 | 74.0 |
| Example (I-4) | 0.0072 | 81.1 | 81.5 | 92.1 | 92.9 |

### Aphids (Aphididae)

Moreover, very particular preference is given to controlling the following species from the family of the aphids, in the following crops:
Myzus persicae in tobacco, in beet, in fruit vegetables and leafy vegetables, such as, for example, bell peppers, tomatoes, aubergines, head lettuce, potatoes, in stone fruit, such as, for example, peaches, nectarines, plums, cherries, strawberries, melons, in ornamental plants, such as, for example, roses
Myzus nicotianae in tobacco
Myzus cerasi in stone fruit, such as, for example, cherries
Aphis gossypii in cereals, such as, for example, wheat, in pomme fruit, such as, for example, apples, pears, in stone fruit, such as, for example, peaches, nectarines, cherries, plums, garden plums, apricots, in citrus fruit, such as, for example, oranges, mandarins, grapefruits, cucurbits, melons, strawberries, oilseed rape, potatoes, beet, in ornamental plants, such as, for example, roses
Aphis pomi in pomme fruit, such as, for example, apples, pears
Dysaphis plantaginea in pomme fruit, such as, for example, apples, pears
Dysaphis piri in pomme fruit, such as, for example, apples, pears
Aphis fabae in beet and beans
Rhodobium porosum in strawberries
Nasonovia ribisnigri in leafy vegetables, such as, for example, head lettuce
Macrosiphum rosae in ornamental plants, such as, for example, roses
Macrosiphum in leafy vegetables, fruit vegetables and brassica vegetables,
euphorbiae such as, for example, aubergines, lettuce, bell peppers, white cabbage, strawberries
Phorodon humuli in hops
Brachycaudus helycrisii in stone fruit, such as, for example, in plums, garden plums
Aulacorthum solani in citrus fruit, such as, for example, oranges, mandarins, grapefruits, limes, in fruit vegetables and leafy vegetables, such as, for example, head lettuce, tomatoes, bell peppers, aubergines
Toxoptera citricola in citrus fruit, such as, for example, oranges, mandarins, limes, grapefruits, in stone fruit, such as, for example, peaches, apricots
Toxoptera citricida in citrus fruit, such as, for example, oranges, mandarins, limes, grapefruits, in stone fruit, such as, for example, peaches, apricots
Toxoptera aurantii in citrus fruit, such as, for example, oranges, mandarins, grapefruits, limes, in spices, such as, for example, pepper, in nuts, such as, for example, cashew nuts
Toxoptera odinae in citrus fruit, such as, for example, oranges, mandarins, grapefruits, limes, in spices, such as, for example, pepper, in nuts, such as, for example, cashew nuts
Toxoptera graminum in cereals, such as, for example, wheat, triticale, sorghum

### Example 40

In three replications, three about 22-year-old apple trees of the cultivar “Golden Delicious” are treated eradicatively against Dysaphis plantaginea and Aphis pomi. The application is carried out using a motor-operated barrow-mounted sprayer. Here, the active compounds Example (I-9) (240 SC) and Example (I-4) (240 SC) in the stated amount are tested against the commercial standard imidacloprid (200 SL), at the stated application rate. The application rate is 1200 l of water/ha.

Evaluation is carried out 14 d and 21 d after the treatment by rating the kill of the population on the shoots.

### Dysaphis Plantaginea

| | |
|---|---|
| Active | Kill (%) |

| compound | Application rate (%) of a.i. | 14 d | 21 d |
|---|---|---|---|
| imidacloprid | 0.007 | 97.6 | 99.8 |
| Example (I-9) | 0.0144 | 99.8 | 100 |
| Example (I-4) | 0.0144 | 99.3 | 100 |

Aphis pomi

| | |
|---|---|
| Active | Kill (%) |

| compound | Application rate (%) of a.i. | 14 d | 21 d |
|---|---|---|---|
| imidacloprid | 0.007 | 93.6 | 92.5 |
| Example (I-9) | 0.0144 | 98.5 | 97.3 |
| Example (I-4) | 0.0144 | 96.9 | 98.8 |

### Example 41

In three replications, three about 8-year-old apple trees of the cultivar “Golden Delicious” are treated eradicatively against Dysaphis plantaginea and Aphis pomi. The application is carried out using a motor-operated barrow-mounted sprayer. Here, the active compounds Example (I-9) (240 SC) and Example (I-2) (240 SC) in the stated amount are tested against the commercial standard imidacloprid (200 SL), at the stated application rate. The application rate is 1200 l of water/ha.

Evaluation is carried out before and also 7 d and 14 d after the treatment by counting the live animals on the shoots. The efficacy is then calculated by calculating the effect on the population in percent according to Henderson and Tilton.

Dysaphis plantaginea

| | |
|---|---|
| Active | Effect (%) |

| compound | Application rate (%) of a.i. | 7 d | 14 d |
|---|---|---|---|
| imidacloprid | 0.007 | 99.6 | 99.5 |
| Example (I-9) | 0.0144 | 92.1 | 99.4 |
| Example (I-2) | 0.0144 | 92.3 | 99.2 |

Aphis pomi

| | |
|---|---|
| Active | Effect (%) |

| compound | Application rate (%) of a.i. | 7 d | 14 d |
|---|---|---|---|
| imidacloprid | 0.007 | 99 | 83.5 |
| Example (I-9) | 0.0144 | 93 | 93.5 |
| Example (I-2) | 0.0144 | 99.1 | 97.1 |

### Example 42

In four replications, plots of a size of 5 m² with head lettuce are, two weeks after transplantation, treated against Nasonovia ribisnigri. The application is carried out using a knapsack sprayer operated with pressurized air. Here, the active compounds Example (I-4) (240 SC) and Example (I-8) (240 SC) are, in a tank mix with 0.2% a.i. of rapeseed oil methyl ester (500 EW), tested against the commercial standard Pirimor, at the stated application rates. The application rate is 500 l of water/ha.

Evaluation is carried out 7, 14 and 26 days after the treatment by rating the kill of the animals on the plants.

| Active | Application rate g of | Kill (%) | | |
|---|---|---|---|---|
| compound | a.i./ha | 7 d | 14 d | 26 d |
| Pirimor | 150 | 69.2 | 53.2 | 46.3 |
| Example (I-4) | 48 | 92.3 | 95.7 | 95.1 |
| Example (I-8) | 42 | 80.8 | 93.6 | 92.7 |

### Example 43

In three replications, plots of a size of 10 m² with aubergines of the cultivar “F 100” are treated against Macrosiphum euphorbiae. The application is carried out using a knapsack sprayer operated with pressurized air. Here, the active compounds Example (I-9) (60 SC), Example (I-2) (60 SC) and Example (I-11) (60 SC) and the commercial standard imidacloprid (70 WG) are tested at the stated application rates. Three applications are carried out, at an interval of 7 or 8 days. The application rate is 1000 l of water/ha.

Evaluation is carried out 7 and 14 days after the second treatment by rating the kill of the nymphs on the leaves.

| | | |
|---|---|---|
| Active | Application | Kill (%) |

| compound | rate (%) of a.i. | 7 d | 14 d |
|---|---|---|---|
| imidacloprid | 0.014 | 100 | 100 |
| Example (I-9) | 0.0144 | 99 | 98 |
| Example (I-2) | 0.0144 | 99 | 91 |
| Example (I-11) | 0.0144 | 98 | 99 |

Very particular preference is given to controlling Phorodon humuli in hops.

### Example 44

In two replications, about 4-year-old hop plants of the cultivar “Spalter” are treated against the hop aphid Phorodon humuli. The application is carried out using a knapsack sprayer operated with pressurized air. Here, the active compounds Example (I-9) (240 SC) and Example (I-4) (240 SC), in a tank mix with 0.1% a.i. of rapeseed oil methyl ester (500 EW), and the standard imidacloprid are applied at the stated application rates. The application rate is 1200 l of water/ha.

The first evaluation is carried out 6 days and the last evaluation 46 days after the treatment by rating the kill of the animals on the leaves.

| | |
|---|---|
| Active | Kill (%) |

| compound | Application rate (%) of a.i. | 6 d | 46 d |
|---|---|---|---|
| imidacloprid | 0.0053 | 99 | 97.6 |
| Example (I-9) | 0.0036 | 95 | 85.2 |
| Example (I-4) | 0.0084 | 95 | 98.7 |

### Example 45

In three replications, in each case one about 8-year-old orange tree of the cultivar “Navel” is treated against Toxoptera citricida. Here, the active compounds Example (I-9) (240 SC) and Example (I-4) (240 SC), in a tank mix with 0.1% a.i. of Marlipal, are tested against the commercial standard imidacloprid (350 SC), at the stated application rates. The application is carried out using a motor-operated knapsack sprayer, the application rate being 6.7 l of water/plant.

Evaluation is carried out 6 and 20 days after the treatment by rating the kill of the animals on the leaves.

| | |
|---|---|
| Active | Kill (%) |

| compound | Application rate (%) of a.i. | 6 d | 20 d |
|---|---|---|---|
| imidacloprid | 0.0125 | 99 | 94 |
| Example (I-9) | 0.0144 | 96 | 97 |
| Example (I-4) | 0.0144 | 97 | 97 |

### Example 46

In four replications, plots of a size of about 33 m² with head lettuce of the cultivar “PIC 714” are treated against Aulacorthum solani, Macrosiphum euphorbiae and Myzus persicae. The application is carried out using a tractor sprayer. Here, the active compound Example (I-4) (240 SC), in a tank mix with 0.2% a.i. of rapeseed oil methyl ester (500 EW), is tested against the commercial standard endosulfan (360 EC), at the stated application rates. The application rate is 187 l of water/ha. Two treatments are carried out, at an interval of 22 days.

Evaluation is carried out 8, 22, 30 and 40 days after the first treatment by rating the kill of the nymphs on the plants.

Aulacorthum solani

| Active | Application rate g | Kill (%) | | | |
|---|---|---|---|---|---|
| compound | of a.i./ha | 8 d | 22 d | 30 d | 40 d |
| endosulfan | 1120 | 96 | 88 | 98 | 53 |
| Example (I-4) | 48 | 100 | 99 | 79 | 87 |

Macrosiphum euphorbiae

| Active | Application rate g of | Kill (%) | | | |
|---|---|---|---|---|---|
| compound | a.i./ha | 8 d | 22 d | 30 d | 40 d |
| endosulfan | 1120 | 100 | 100 | 99 | 96 |
| Example (I-4) | 48 | 95 | 100 | 100 | 96 |

Myzus persicae

| Active | Application rate g of | Kill (%) | | | |
|---|---|---|---|---|---|
| compound | a.i./ha | 8 d | 22 d | 30 d | 40 d |
| endosulfan | 1120 | 95 | 61 | 100 | —* |
| Example (I-4) | 48 | 95 | 100 | 88 | —* |

*no animals in the control

### Example 47

In three replications, under practical conditions, about 18-year-old peach trees of the cultivar “Vivian” infested with Myzus persicae are treated with Example (I-4) (240 SC) in a tank mix with 0.2% a.i. of rapeseed oil methyl ester (500 EW) in comparison to the commercial standard imidacloprid 200 SL, at the stated application rates. The application is carried out using a motor-operated knapsack sprayer. The application rate is 1000 l of water/ha.

Evaluation is carried out 7, 14 and 21 days after the application by counting the live animals on the shoots. The efficacy is then calculated by calculating the effect on the population in percent according to Henderson and Tilten.

| Active | Application rate of a.i. in | Effect (%) | | |
|---|---|---|---|---|
| compound | g/ha/crown height in m | 7 d | 14 d | 21 d |
| imidacloprid | 25 | 97.6 | 95.8 | 78.1 |
| Example (I-4) | 24 | 94.0 | 98.9 | 93.3 |

### Example 48

In three replications, four aubergine plants (age about 7 months) of the cultivar “Hayabusa” are treated against Myzus persicae. The application is carried out using a motor-operated knapsack sprayer. Here, the active compound Example (I-4) (240 SC), in a tank mix with 0.1% a.i. of rapeseed oil methyl ester (500 EW), and the commercial standard pymethrozine (25 WP) are tested at the stated application rates. The application rate is 3000 l of water/ha.

Evaluation is carried out 7, 14, 21 and 29 days after the treatment by rating the kill of the animals on the leaves.

| Active | Application rate g of | Kill (%) | | | |
|---|---|---|---|---|---|
| compound | a.i./ha | 7 d | 14 d | 21 d | 29 d |
| pymethrozine | 0.0125 | 99.9 | 99 | 95 | 73 |
| Example (I-4) | 0.024 | 99.7 | 99.7 | 98 | 97 |

### Example 49

In four replications, plots of a size of about 7.5 m² with potatoes of the cultivar “BP 1” are treated against Myzus persicae. The application is carried out using a knapsack sprayer operated with pressurized air. Here, the active compound Example (I-4) (240 SC), in a tank mix with 0.2% a.i. of rapeseed oil methyl ester (500 EW), and the commercial standard Tamaron (585 SL) are tested at the stated application rates. Two applications are carried out, at an interval of 7 days. The application rate is 500 l of water/ha.

Evaluation is carried out 7 and 13 days after the first treatment by counting the live animals (nymphs) on the leaves. The efficacy is then calculated by calculating the effect on the population in percent according to Henderson and Tilten.

| | | |
|---|---|---|
| Active | Application rate g of | Effect (%) |

| compound | a.i./ha | 7 d | 13 d |
|---|---|---|---|
| Tamaron | 585 | 100 | 100 |
| Example (I-4) | 48 | 67 | 100 |

### Example 50

In two replications, plots of a size of about 43 m² with tomatoes of the cultivar “Yaqui” are treated against Myzus persicae. The application is carried out using a motor-operated knapsack sprayer. Here, the active compounds Example (I-9) (240 SC) and Example (I-4) (240 SC), in a tank mix with 0.1% a.i. of rapeseed oil methyl ester (500 EW), and the standard acetamiprid (20 WP) are applied at the stated application rates. The application rate is 208 l of water/ha.

Evaluation is carried out 3 and 10 days after the treatment by rating the kill of the nymphs on the leaves.

| | | |
|---|---|---|
| Active | Application rate g of | Kill (%) |

| compound | a.i./ha | 3 d | 10 d |
|---|---|---|---|
| acetamiprid | 50 | 78.7 | 73.5 |
| Example (I-9) | 36 | 87.5 | 95.9 |
| Example (I-4) | 48 | 92.6 | 95.9 |

### Example 51

In three replications, plots of a size of 10 m² with broad beans of the cultivar “Fruhe Weisskeimige” are treated against Aphis fabae. The application is carried out using a knapsack sprayer operated with pressurized air. Here, the active compounds Example (I-9) (240 SC), Example (I-2) (240 SC) and Example (I-4) (240 SC), in a tank mix with 0.2% of rapeseed oil methyl ester (500 EW), and the commercial standard Pirimor (50 WG) are tested at the stated application rates. Application is carried out once. The application rate is 500 l of water/ha.

Evaluation is carried out 7 and 15 days after the treatment by rating the kill of the nymphs on the leaves.

| | | |
|---|---|---|
| Active | Application rate g of | Kill (%) |

| compound | a.i./ha | 7 d | 15 d |
|---|---|---|---|
| Pirimor | 250 | 100 | 100 |
| Example (I-9) | 36 | 99.7 | 100 |
| Example (I-2) | 36 | 98.6 | 100 |
| Example (I-4) | 42 | 100 | 100 |

### Example 52

In three replications, plots of a size of 15 m² with melons are treated against Aphis gossypii. The application is carried out using a knapsack sprayer operated with pressurized air. Here, the active compound Example (I-4) (240 SC), in a tank mix with 0.1% a.i. of rapeseed oil methyl ester (500 EW), and the standard imidacloprid (200 SL) are applied at the stated application rates. The application rate is 500 l of water/ha.

Evaluation is carried out 3 days and 7 days after the treatment by rating the kill of the animals on the shoots.

| | | |
|---|---|---|
| Active | Application rate g of | Kill (%) |

| compound | a.i./ha | 3 d | 7 d |
|---|---|---|---|
| imidacloprid | 100 | 98.2 | 100 |
| Example (I-4) | 48 | 94.7 | 100 |

### Example 53

In four replications, plum trees of the cultivar “Angeleno” of a height of about 2.8 m are treated against Myzus persicae. The application is carried out using a high-pressure sprayer. Here, the active compound Example (I-4) (100 OD), in the stated amount, is tested against the commercial standard Actara (25 WG), at the stated application rate. The application rate is 500 l of water/ha/crown height in m.

Evaluation is carried out 6, 9, 12, 20 days after the treatment by rating the kill of the population on the shoots.

| | Application rate | | | | | |
|---|---|---|---|---|---|---|
| Active | g of a.i./ha/crown | Kill (%) | | | | |
| compound | height in m | 6 d | 9 d | 12 d | 20 d | 27 d |
| Actara | 33.5 | 96.7 | 96.6 | 86.9 | 88.4 | 89.2 |
| Example (I-4) | 48 | 96.4 | 99.7 | 99.8 | 99.9 | 99.9 |

### Example 54

In four replications, plots of a size of about 8.4 m² with 36 11-week-old bell pepper plants of the cultivar “Casea dura ikeda” are treated against Myzus persicae. The application is carried out using a knapsack sprayer operated with pressurized air. Here, the active compound Example (I-4) (240 SC), in a tank mix with 0.2% a.i. of rapeseed oil methyl ester (500 EW), is tested against the commercial standard Provado (200 SC), at the stated application rates. The application rate is 600 l of water/ha. There are three applications, in each case at an interval of 7 d.

Evaluation is carried out 1, 7, and 14 days after the last treatment by rating the kill of the animals on the leaves.

| Active | Application | Kill (%) | | |
|---|---|---|---|---|
| compound | rate g of a.i./ha | 1 d | 7 d | 14 d |
| Provado | 50 | 99.7 | 100 | 98.7 |
| Example (I-4) | 48 | 99.1 | 98.5 | 100 |

### Example 55

In four replications, plots of a size of about 3 m² with 3-week-old strawberry plants are treated against Macrosiphum euphorbiae and Rhodobium porosum. The application is carried out using a knapsack sprayer operated with pressurized air. Here, the active compound Example (I-4) (150 OD) and the commercial standard Calypso (480 SC) are tested at the stated application rates. Here, the standard is sprayed as a tank mix with 0.03% of Motto (adjuvant). The application rate is 500 l of water/ha.

Evaluation is carried out 7 and 14 days after the second treatment by rating the kill of the nymphs on the plants.

| | | Rhodobium | | Macrosiphum | |
|---|---|---|---|---|---|
| | | porosum | | euphorbiae | |
| Active | Application rate | Kill (%) | | Kill (%) | |
| compound | g of a.i./ha | 7 d | 14 d | 7 d | 14 d |
| Calypso | 120 | 99 | 98 | 67.7 | 96 |
| Example (I-4) | 75 | 97 | 96 | 62.2 | 94 |

1. A method for controlling insects from the suborder of the plant lice (Sternorrhyncha) comprising contacting said insects with a compound of the formula (I) 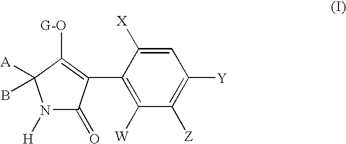
in which
X represents halogen, alkyl, alkoxy, haloalkyl, haloalkoxy or cyano,
W, Y and Z independently of one another represent hydrogen, halogen, alkyl, alkoxy, haloalkyl, haloalkoxy or cyano,
A represents hydrogen, in each case optionally halogen-substituted alkyl, alkoxyalkyl, or saturated, optionally substituted cycloalkyl in which optionally at least one ring atom is replaced by a heteroatom,
B represents hydrogen or alkyl, or
A and B together with the carbon atom to which they are attached represent a saturated or unsaturated, unsubstituted or substituted cycle which optionally contains at least one heteroatom,
G represents hydrogen (a) or represents one of the groups 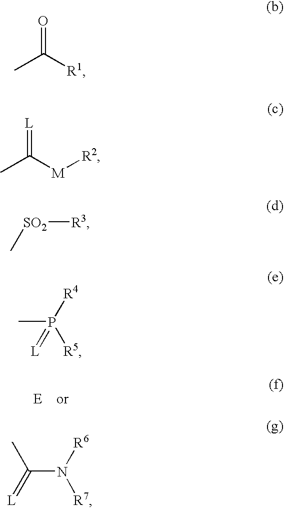
in which
E represents a metal ion or an ammonium ion,
L represents oxygen or sulphur,
M represents oxygen or sulphur,
R¹ represents in each case optionally halogen-substituted alkyl, alkenyl, alkoxyalkyl, alkylthioalkyl, polyalkoxyalkyl or optionally halogen-, alkyl- or alkoxy-substituted cycloalkyl which may be interrupted by at least one heteroatom, or represents in each case optionally substituted phenyl, phenylalkyl, hetaryl, phenoxyalkyl or hetaryl-oxyalkyl,
R² represents in each case optionally halogen-substituted alkyl, alkenyl, alkoxyalkyl, polyalkoxyalkyl or represents in each case optionally substituted cycloalkyl, phenyl or benzyl,
R³ represents optionally halogen-substituted alkyl or optionally substituted phenyl,
R⁴ and R⁵ independently of one another represent in each case optionally halogen-substituted alkyl, alkoxy, alkylamino, dialkylamino, alkylthio, alkenylthio, cycloalkylthio or represent in each case optionally substituted phenyl, benzyl, phenoxy or phenylthio and
R⁶ and R⁷ independently of one another represent hydrogen, in each case optionally halogen-substituted alkyl, cycloalkyl, alkenyl, alkoxy, alkoxyalkyl, represent optionally substituted phenyl, represent optionally substituted benzyl or together with the nitrogen atom to which they are attached represent an optionally substituted ring which is optionally interrupted by oxygen or sulphur,
in the form of their isomer mixtures or pure isomers.

2. The method according to claim 1,
wherein
W represents hydrogen, C₁-C₄-alkyl, C₁-C₄-alkoxy, chlorine, bromine or fluorine,
X represents C₁-C₄-alkyl, C₁-C₄-alkoxy, C₁-C₄-haloalkyl, fluorine, chlorine or bromine,
Y and Z independently of one another represent hydrogen, C₁-C₄-alkyl, halogen, C₁-C₄-alkoxy or C₁-C₄-haloalkyl,
A represents hydrogen or in each case optionally halogen-substituted C₁-C₆-alkyl or C₃-C₈-cycloalkyl,
B represents hydrogen, methyl or ethyl, or
A, B and the carbon atom to which they are attached represent saturated C₃-C₆-cycloalkyl in which optionally one ring member is replaced by oxygen or sulphur and which is optionally mono- or disubstituted by C₁-C₄-alkyl, trifluoromethyl or C₁-C₄-alkoxy,
G represents hydrogen (a) or represents one of the groups 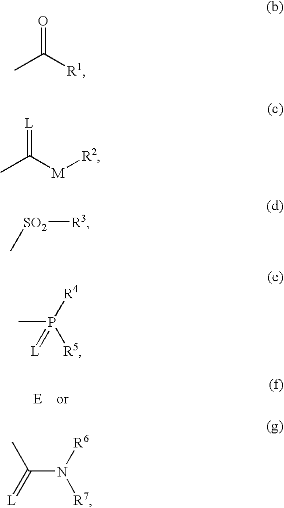
in which
E represents a metal ion or an ammonium ion,
L represents oxygen or sulphur and
M represents oxygen or sulphur,
R¹ represents in each case optionally halogen-substituted C₁-C₁₀-alkyl, C₂-C₁₀-alkenyl, C₁-C₄-alkoxy-C₁-C₄-alkyl, C₁-C₄-alkylthio-C₁-C₄-alkyl or optionally fluorine-, chlorine-, C₁-C₄-alkyl- or C₁-C₂-alkoxy-substituted C₃-C₆-cycloalkyl,
represents optionally fluorine-, chlorine-, bromine-, cyano-, nitro-, C₁-C₄-alkyl-, C₁-C₄-alkoxy-, trifluoromethyl- or trifluoromethoxy-substituted phenyl, or
represents in each case optionally chlorine- or methyl-substituted pyridyl or thienyl,
R² represents in each case optionally fluorine- or chlorine-substituted C₁-C₁₀-alkyl, C₂-C₁₀-alkenyl, C₁-C₄-alkoxy-C₂-C₄-alkyl,
represents optionally methyl- or methoxy-substituted C₅-C₆-cycloalkyl or
represents in each case optionally fluorine-, chlorine-, bromine-, cyano-, nitro-, C₁-C₄-alkyl-, C₁-C₄-alkoxy-, trifluoromethyl- or trifluoromethoxy-substituted phenyl or benzyl,
R³ represents optionally fluorine-substituted C₁-C₄-alkyl or represents optionally fluorine-, chlorine-, bromine-, C₁-C₄-alkyl-, C₁-C₄-alkoxy-, trifluoromethyl-, trifluoromethoxy-, cyano- or nitro-substituted phenyl,
R⁴ represents in each case optionally fluorine- or chlorine-substituted C₁-C₄-alkyl, C₁-C₄-alkoxy, C₁-C₄-alkylamino, C₁-C₄-alkylthio or represents in each case optionally fluorine-, chlorine-, bromine-, nitro-, cyano-, C₁-C₄-alkoxy-, trifluoromethoxy-, C₁-C₄-alkylthio-, C₁-C₄-haloalkylthio-, C₁-C₄-alkyl- or trifluoromethyl-substituted phenyl, phenoxy or phenylthio,
R⁵ represents C₁-C₄-alkoxy or C₁-C₄-thioalkyl,
R⁶ represents C₁-C₆-alkyl, C₃-C₆-cycloalkyl, C₁-C₆-alkoxy, C₃-C₆-alkenyl or C₁-C₄-alkoxy-C₁-C₄-alkyl,
R⁷ represents C₁-C₆-alkyl, C₃-C₆-alkenyl or C₁-C₄-alkoxy-C₁-C₄-alkyl, or
R⁶ and R⁷ together represent an optionally methyl- or ethyl-substituted C₃-C₆-alkylene radical in which optionally one carbon atom is replaced by oxygen or sulphur,
in the form of their isomer mixtures or pure isomers.

3. The method according to claim 1,
wherein
W represents hydrogen, methyl, ethyl, chlorine, bromine or methoxy,
X represents chlorine, bromine, methyl, ethyl, propyl, isopropyl, methoxy, ethoxy or trifluoromethyl,
Y and Z independently of one another represent hydrogen, fluorine, chlorine, bromine, methyl, ethyl, propyl, isopropyl, trifluoromethyl or methoxy,
A represents methyl, ethyl, propyl, isopropyl, butyl, isobutyl, sec-butyl, tert-butyl, cyclopropyl, cyclopentyl or cyclohexyl,
B represents hydrogen, methyl or ethyl, or
A, B and the carbon atom to which they are attached represent saturated C₆-cycloalkyl in which optionally one ring member is replaced by oxygen and which is optionally monosubstituted by methyl, ethyl, trifluoromethyl, methoxy, ethoxy, propoxy or butoxy,
G represents hydrogen (a) or represents one of the groups 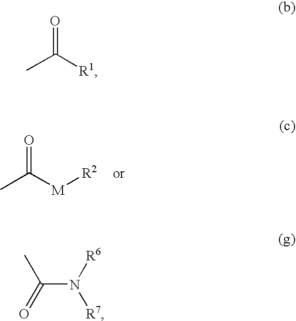
in which
M represents oxygen or sulphur,
R¹ represents C₁-C₈-alkyl, C₂-C₄-alkenyl, methoxymethyl, ethoxymethyl, ethylthiomethyl, cyclopropyl, cyclopentyl or cyclohexyl, or
represents phenyl which is optionally mono- or disubstituted by fluorine, chlorine, bromine, cyano, nitro, methyl, ethyl, methoxy, trifluoromethyl or trifluoromethoxy,
or represents in each case optionally chlorine- or methyl-substituted pyridyl or thienyl,
R² represents C₁-C₈-alkyl, C₂-C₄-alkenyl, methoxyethyl, ethoxyethyl or represents phenyl or benzyl,
R⁶ and R⁷ independently of one another represent methyl, ethyl or together represent a C₅-alkylene radical in which the C₃-methylene group is replaced by oxygen,
in the form of their isomer mixtures or pure isomers.

4. The method according to claim 1,
wherein
W represents hydrogen or methyl,
X represents chlorine, bromine or methyl,
Y and Z independently of one another represent hydrogen, chlorine, bromine or methyl,
A, B and the carbon atom to which they are attached represent saturated C₆-cycloalkyl in which optionally one ring member is replaced by oxygen and which is optionally monosubstituted by methyl, trifluoromethyl, methoxy, ethoxy, propoxy or butoxy,
G represents hydrogen (a) or represents one of the groups 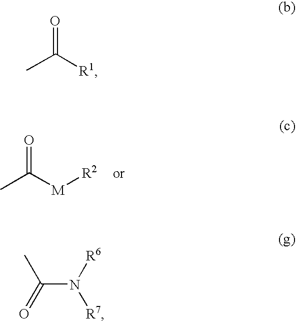
in which
M represents oxygen or sulphur,
R¹ represents C₁-C₈-alkyl, C₂-C₄-alkenyl, methoxymethyl, ethoxymethyl, ethylthiomethyl, cyclopropyl, cyclopentyl, cyclohexyl or
represents phenyl which is optionally monosubstituted by fluorine, chlorine, bromine, methyl, methoxy, trifluoromethyl, trifluoromethoxy, cyano or nitro, or
represents in each case optionally chlorine- or methyl-substituted pyridyl or thienyl,
R² represents C₁-C₈-alkyl, C₂-C₄-alkenyl, methoxyethyl, ethoxyethyl, phenyl or benzyl,
R⁶ and R⁷ independently of one another represent methyl, ethyl or together represent a C₅-alkylene radical in which the C₃-methylene group is replaced by oxygen,
in the form of their isomer mixtures or pure isomers.

5. The method according to claim 1, wherein said compound is a compound of the formula (I) 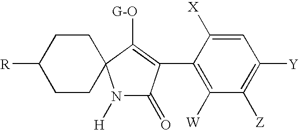
wherein the substituents W, X, Y, Z, R and G are as defined in the table:

| W | X | Y | Z | R | G |
|---|---|---|---|---|---|
| H | Br | H | CH₃ | OCH₃ | CO-i-C₃H₇ |
| H | Br | H | CH₃ | OCH₃ | CO₂—C₂H₅ |
| H | CH₃ | H | CH₃ | OCH₃ | H |
| H | CH₃ | H | CH₃ | OCH₃ | CO₂—C₂H₅ |
| CH₃ | CH₃ | H | Br | OCH₃ | H |
| CH₃ | CH₃ | H | Cl | OCH₃ | H |
| H | Br | CH₃ | CH₃ | OCH₃ | CO-i-C₃H₇ |
| H | CH₃ | Cl | CH₃ | OCH₃ | CO₂C₂H₅ |
| CH₃ | CH₃ | CH₃ | CH₃ | OCH₃ | H |
| CH₃ | CH₃ | H | Br | OC₂H₅ | CO-i-C₃H₇ |
| H | CH₃ | CH₃ | CH₃ | OC₂H₅ | CO-n-C₃H₇ |
| H | CH₃ | CH₃ | CH₃ | OC₂H₅ | CO-i-C₃H₇ |
| H | CH₃ | CH₃ | CH₃ | OC₂H₅ | CO-c-C₃H₅ |

6. A method according to claim 1, wherein said insect is from the family of the gall-making aphids (Pemphigidae).

7. A method according to claim 1, wherein said insect is from the family of the phylloxerans (Phylloxeridae).

8. A method according to claim 1, wherein said insect is from the family of the jumping plant lice (Psyllidae).

9. A method according to claim 1, wherein said insect is from the family of the soft scales (Coccidae).

10. A method according to claim 1, wherein said insect is from the family of the armoured scales (Diaspididae).

11. A method according to claim 1, wherein said insect is from the family of the ensign coccids (Ortheziidae).

12. A method according to claim 1, wherein said insect is from the family of the mealy bugs (Pseudococcidae).

13. A method according to claim 1, wherein said insect is from the family of the whiteflies (Aleyrodidae) other than the whiteflies Bemisia tabaci (Aleyrodidae) on cotton.

14. A method according to claim 1 for controlling Myzus spp. in tobacco, cereals, stone fruit, soft fruit, fruit vegetables, leafy vegetables, tuber and root vegetables, melons, potatoes, beet, oilseed rape or ornamental plants.

15. A method according to claim 1 for controlling Aphis spp. in tobacco, citrus fruit, pomme fruit, stone fruit, cereals, melons, beet, soft fruit, oilseed rape, fruit vegetables, leafy vegetables, brassica vegetables, tuber and root vegetables, ornamental plants, potatoes or cucurbits.

16. A method according to claim 1 for controlling Rhodobium porosum in strawberries.

17. A method according to claim 1 for controlling Nasonovia ribisnigri in leafy vegetables.

18. A method according to claim 1 for controlling Dysaphis spp. in pomme fruit.

19. A method according to claim 1 for controlling Macrosiphum spp. in ornamental plants, cereals, potatoes, leafy vegetables, brassica vegetables and fruit vegetables or strawberries.

20. A method according to claim 1 for controlling Rhopalosiphum padi, Sitobion avenae, Methopolophium dirhodum, or Brachycolus noxius in cereals.

21. A method according to claim 1 for controlling Phorodon humuli in hops.

22. A method according to claim 1 for controlling Brachycaudus helychrisii in stone fruit.

23. A method according to claim 1 for controlling Toxoptera spp. in citrus fruit, stone fruit, almonds, nuts, cereals or spices.

24. A method according to claim 1 for controlling Aulacorthum spp. in citrus fruit, potatoes, fruit vegetables or leafy vegetables.
